(19) United States
(12) Patent Application Publication
(10) Pub. No.: US 2026/0148196 A1
(43) Pub. Date: May 28, 2026

(54) TIME/DATE ADJUSTMENT APPARATUS, TIME/DATE ADJUSTMENT METHOD, AND STORAGE MEDIUM STORING PROGRAM

(71) Applicant: E4 Inc., Tokyo (JP)

(72) Inventor: Taichiro SUGIMOTO, Tokyo (JP)

(21) Appl. No.: 19/125,929

(22) PCT Filed: Sep. 26, 2023
(86) PCT No.: PCT/JP2023/034943

§ 371 Date: Apr. 30, 2025

(30) Foreign Application Priority Data
Nov. 16, 2022 (JP) 2022-183089

(51) Int. Cl. G06Q 10/1093

(52) U.S. Cl. CPC G06Q 10/1093

(57) ABSTRACT

A time/date adjustment apparatus includes an adjustment condition setting unit that sets, in response to an input of an adjustment initiator, an adjustment condition including designation of an adjustment initiator-side participant and designation of a determination criterion as to whether or not to add an adjustment partner-side participant to an item of an assembly participant of plan information to be registered in schedule information of the adjustment initiator-side participant, and a time/date adjustment unit that registers the plan information of a determined assembly time/date in the schedule information of the adjustment initiator-side participant, with the adjustment initiator-side participant being designated as the item of the assembly participant of the plan information, and adds or does not add the adjustment partner-side participant to the item of the assembly participant of the plan information to be registered, according to the determination criterion.

### TECHNICAL FIELD

The present invention relates to a time/date adjustment apparatus, a time/date adjustment method, and a program. The present invention claims priority based on Japanese Patent Application No. 2022-183089 filed on Nov. 16, 2022, the contents of which are incorporated herein by reference for designated states where incorporation of literature by reference is permitted.

### BACKGROUND ART

Conventionally, adjustment of a time/date (time and date) of an assembly in business requires a large number of steps such as checking of a schedule of each participant and securing a site, and is therefore considerably bothersome work taking time and efforts.

Note that, Regarding checking of schedules of participants,

it is considered that a calendar tool is referred to, as many businesspersons manage theirs plans using a calendar tool provided on the Internet in recent years.

Regarding the calendar tool, for example, PTL 1 provides the following description: “a schedule information sharing method including the steps of: performing membership application registration by each of a plurality of applicants and a plurality of users, the plurality of applicants applying for distribution of schedule information, the plurality of users using the schedule information the distribution, the plurality of applicants and the plurality of users each being a member of a system that distributes and shares the schedule information via the Internet; executing by a scheduler performing schedule management below; disclosing and distributing, by the applicant, the schedule information to the user; registering, by the user, a target desiring distribution of the disclosed schedule information; and based on a registered desired distribution target of the user, synchronizing and presetting the schedule information related thereto to a calendar of all of user terminals.”

### CITATION LIST

### Patent Literature

PTL 1: JP 2019-219831 A

### SUMMARY OF INVENTION

### Technical Problem

In a technique described in PTL 1, a plurality of users being members of a system can share schedule information with each other, and use the schedule information for adjustment of a time/date of an assembly. However, even if the system is used, schedules of participants in a meeting or the like may be updated and changed from moment to moment, which makes it difficult to perform adjustment of a time/date of the assembly without causing an overlap between existing plans of each of the participants and time at which the assembly is held, in other words, without causing a double booking.

After adjustment of a time/date of an assembly is completed, details for the assembly may be shared with a person as an assembly participant of the plan by using memo information, an attached file, or the like in the plan registered in the calendar tool. Note that, in a general calendar tool, when all of the assembly participants use the calendar tool of the same type, the plan, the memo information of the plan, and the like are automatically shared among the assembly participants designated in the plan (even among calendar tools of different types, the plan, the memo information, and the like may be automatically shared by registering email addresses in the item of the assembly participants of the plan). To effectively use the automatic sharing function of the calendar tools, a common method is that a participant, among the people to participate in the same assembly, with which the plan and the memo information of the plan are to be shared is added to an item of the assembly participants in the plan to be registered in the calendar tool of their company, whereas a participant, among the people to participate in the same assembly, with which the plan and the memo information of the plan are not to be shared is not added to the item of the assembly participants. Owing to the method, information can be efficiently shared with a part of the people to participate in the assembly, whereas the assembly can be attended with confidentiality of information described in the memo information of the plan being kept for another part of the people. Note that a common use method is that a member belonging to the same organization is included in the item of the assembly participants in the plan and a member outside of the company (a client or the like) is not included in the item of the assembly participants in the plan.

For example, in a case of a plan where company a has a business discussion with company b, regarding the plan to be registered in the calendar tool used by company a, only business discussion participant members belonging to company a are included in the item of the assembly participants in the plan, and the memo information and the like in the plan for the business discussion are shared only among the business discussion participant members belonging to company a. In other words, because there is a firm intention that the memo information and the like in the plan for the business discussion are not to be shared with people belonging to company b being a business discussion partner, it is convenient that the people belonging to company b being the business discussion partner are not included in the item of the assembly participants of the plan in the calendar used by company a. Meanwhile, for example, when subordinate x has an assembly with y being their boss in company a, regarding the plan to be registered by subordinate x in the calendar tool, by registering the plan with subordinate x and boss y being included in the item of the assembly participants in the plan, subordinate x and boss y share details to be shared in advance via the memo information of the registered plan and the like.

In other words, when adjustment of a time/date is involved, regarding the plan to be registered in the calendar tool on the adjustment initiator side (assembly organizer side) after the time/date is adjusted, it is desirable that whether or not to include adjustment partners in the item of the assembly participants in the plan be determined depending on a relationship between the adjustment initiator and the adjustment partners.

The present invention is made in view of such circumstances as described above, and has an object to enable easy switching between individual registration of a confirmed plan in a schedule of each of an adjustment initiator and an adjustment partner and integrated registration of both of the confirmed plan to be registered in the schedule of the adjustment initiator and the confirmed plan to be registered in the schedule of the adjustment partner in the schedule of the adjustment initiator depending on assembly details or belonging of the adjustment partner, simultaneously with enabling easy adjustment of a time/date of an assembly, without causing a double booking.

### Solution to Problem

The present application includes a plurality of solutions to at least a part of the problems described above, examples of which are described as follows.

In order to solve the problems described above, a time/date adjustment apparatus according to one aspect of the present invention includes an adjustment condition setting unit configured to set an adjustment condition related to an assembly, and a time/date adjustment unit configured to adjust an assembly time/date based on the adjustment condition. The adjustment condition setting unit sets, in response to an input of an adjustment initiator, the adjustment condition including designation of an adjustment initiator-side participant and designation of a determination criterion as to whether or not to add an adjustment partner-side participant to an item of an assembly participant of plan information to be registered in schedule information of the adjustment initiator-side participant. The time/date adjustment unit extracts, in response to an adjustment partner performing access based on access information, available time/dates of the adjustment initiator-side participant as candidate time/dates. The time/date adjustment unit causes a terminal apparatus used by the adjustment partner to display a time/date adjustment screen presenting the extracted candidate time/dates. The time/date adjustment unit determines, in response to a selection operation of the adjustment partner on the time/date adjustment screen, the assembly time/date out of the candidate time/dates. The time/date adjustment unit registers the plan information of the determined assembly time/date in the schedule information of the adjustment initiator-side participant, with the adjustment initiator-side participant being designated as the item of the assembly participant of the plan information. The time/date adjustment unit adds or does not add the adjustment partner-side participant to the item of the assembly participant of the plan information to be registered, according to the determination criterion.

A time/date adjustment apparatus according to another aspect of the present invention includes an adjustment condition setting unit configured to set an adjustment condition related to an assembly, and a time/date adjustment unit configured to adjust an assembly time/date based on the adjustment condition. The adjustment condition setting unit sets, in response to an input of an adjustment initiator or a member administrator of an organization to which the adjustment initiator belongs, a determination condition for determining whether or not an adjustment partner-side participant belongs to a same organization as the adjustment initiator. The adjustment condition setting unit sets, in response to the input of the adjustment initiator, the adjustment condition including designation of an adjustment initiator-side participant. The time/date adjustment unit extracts, in response to an adjustment partner performing access based on access information, available time/dates of the adjustment initiator-side participant as candidate time/dates. The time/date adjustment unit causes a terminal apparatus used by the adjustment partner to display a time/date adjustment screen presenting the extracted candidate time/dates. The time/date adjustment unit determines, in response to a selection operation of the adjustment partner on the time/date adjustment screen, the assembly time/date out of the candidate time/dates. The time/date adjustment unit determines whether or not the adjustment partner-side participant belongs to the same organization as the adjustment initiator, based on the determination condition. The time/date adjustment unit registers plan information of the determined assembly time/date in schedule information of the adjustment initiator-side participant, with the adjustment initiator-side participant being designated as an item of an assembly participant of the plan information. When the adjustment partner-side participant belongs to the same organization as the adjustment initiator, the time/date adjustment unit adds the adjustment partner-side participant to the item of the assembly participant of the plan information to be registered.

The plan information registered in the schedule information and the plan information edited after being registered can be shared between the adjustment initiator-side participant designated as the item of the assembly participant of the plan information registered in the schedule information and the adjustment partner-side participant added to the item of the assembly participant of the plan information registered in the schedule information.

The adjustment condition setting unit can set at least one of an email domain and an email address as the determination condition. The time/date adjustment unit can determine whether or not the adjustment partner-side participant belongs to the same organization as the adjustment initiator, based on the email address of the adjustment partner-side participant and the determination condition.

The time/date adjustment apparatus can include a storage unit configured to store belonging member information presenting a list of belonging members belonging to the same organization. The time/date adjustment unit can refer to the belonging member information corresponding to the adjustment initiator, and thereby determine whether or not the adjustment partner-side participant belongs to the same organization as the adjustment initiator.

The time/date adjustment unit can refer to, in response to the adjustment partner performing access based on the access information, the schedule information of the adjustment initiator-side participant managed by a calendar tool, and extract the available time/dates of the adjustment initiator-side participant satisfying the adjustment condition as the candidate time/date.

The time/date adjustment unit can register, in response to an operation from the adjustment partner, the plan information of the determined assembly time/date in the schedule information of the adjustment partner-side participant.

A time/date adjustment method according to yet another aspect of the present invention includes an adjustment condition setting step of setting an adjustment condition related to an assembly, and a time/date adjustment step of adjusting an assembly time/date based on the adjustment condition. The adjustment condition setting step includes, in response to an input of an adjustment initiator, setting the adjustment condition including designation of an adjustment initiator-side participant and designation of a determination criterion as to whether or not to add an adjustment partner-side participant to an item of an assembly participant of plan information to be registered in schedule information of the adjustment initiator-side participant. The time/date adjustment step includes, in response to an adjustment partner performing access based on access information, extracting available time/dates of the adjustment initiator-side participant as candidate time/dates. The time/date adjustment step includes causing a terminal apparatus used by the adjustment partner to display a time/date adjustment screen presenting the extracted candidate time/dates. The time/date adjustment step includes, in response to a selection operation of the adjustment partner on the time/date adjustment screen, determining the assembly time/date out of the candidate time/dates. The time/date adjustment step includes registering the plan information of the determined assembly time/date in the schedule information of the adjustment initiator-side participant, with the adjustment initiator-side participant being designated as the item of the assembly participant of the plan information. The time/date adjustment step includes adding or not adding the adjustment partner-side participant to the item of the assembly participant of the plan information to be registered, according to the determination criterion.

A program according to yet another aspect of the present invention causes a computer to function as an adjustment condition setting unit configured to set an adjustment condition related to an assembly, and a time/date adjustment unit configured to adjust an assembly time/date based on the adjustment condition. The adjustment condition setting unit sets, in response to an input of an adjustment initiator, the adjustment condition including designation of an adjustment initiator-side participant and designation of a determination criterion as to whether or not to add an adjustment partner-side participant to an item of an assembly participant of plan information to be registered in schedule information of the adjustment initiator-side participant. The time/date adjustment unit extracts, in response to an adjustment partner performing access based on access information, available time/dates of the adjustment initiator-side participant as candidate time/dates. The time/date adjustment unit causes a terminal apparatus used by the adjustment partner to display a time/date adjustment screen presenting the extracted candidate time/dates. The time/date adjustment unit determines, in response to a selection operation of the adjustment partner on the time/date adjustment screen, the assembly time/date out of the candidate time/dates. The time/date adjustment unit registers the plan information of the determined assembly time/date in the schedule information of the adjustment initiator-side participant, with the adjustment initiator-side participant being designated as the item of the assembly participant of the plan information. The time/date adjustment unit adds or does not add the adjustment partner-side participant to the item of the assembly participant of the plan information to be registered, according to the determination criterion.

A time/date adjustment method according to yet another aspect of the present invention includes an adjustment condition setting step of setting an adjustment condition related to an assembly, and a time/date adjustment step of adjusting an assembly time/date based on the adjustment condition. The adjustment condition setting step includes, in response to an input of an adjustment initiator or a member administrator of an organization to which the adjustment initiator belongs, setting a determination condition for determining whether or not an adjustment partner-side participant belongs to a same organization as the adjustment initiator. The adjustment condition setting step includes, in response to the input of the adjustment initiator, setting the adjustment condition including designation of an adjustment initiator-side participant. The time/date adjustment step includes, in response to an adjustment partner performing access based on access information, extracting available time/dates of the adjustment initiator-side participant as candidate time/dates. The time/date adjustment step includes causing a terminal apparatus used by the adjustment partner to display a time/date adjustment screen presenting the extracted candidate time/dates. The time/date adjustment step includes, in response to a selection operation of the adjustment partner on the time/date adjustment screen, determining the assembly time/date out of the candidate time/dates. The time/date adjustment step includes determining whether or not the adjustment partner-side participant belongs to the same organization as the adjustment initiator, based on the determination condition. The time/date adjustment step includes registering plan information of the determined assembly time/date in schedule information of the adjustment initiator-side participant, with the adjustment initiator-side participant being designated as an item of an assembly participant of the plan information. When the adjustment partner-side participant belongs to the same organization as the adjustment initiator, the time/date adjustment step includes adding the adjustment partner-side participant to the item of the assembly participant of the plan information to be registered.

A program according to yet another aspect of the present invention causes a computer to function as an adjustment condition setting unit configured to set an adjustment condition related to an assembly, and a time/date adjustment unit configured to adjust an assembly time/date based on the adjustment condition. The adjustment condition setting unit sets, in response to an input of an adjustment initiator or member administrator of an organization to which the adjustment initiator belongs, a determination condition for determining whether or not an adjustment partner-side participant belongs to a same organization as the adjustment initiator. The adjustment condition setting unit sets, in response to the input of the adjustment initiator, the adjustment condition including designation of an adjustment initiator-side participant. The time/date adjustment unit extracts, in response to an adjustment partner performing access based on access information, available time/dates of the adjustment initiator-side participant as candidate time/dates. The time/date adjustment unit causes a terminal apparatus used by the adjustment partner to display a time/date adjustment screen presenting the extracted candidate time/dates. The time/date adjustment unit determines, in response to a selection operation of the adjustment partner on the time/date adjustment screen, the assembly time/date out of the candidate time/dates. The time/date adjustment unit determines whether or not the adjustment partner-side participant belongs to the same organization as the adjustment initiator, based on the determination condition. The time/date adjustment unit registers plan information of the determined assembly time/date in schedule information of the adjustment initiator-side participant, with the adjustment initiator-side participant being designated as an item of an assembly participant of the plan information. When the adjustment partner-side participant belongs to the same organization as the adjustment initiator, the time/date adjustment unit adds the adjustment partner-side participant to the item of the assembly participant of the plan information to be registered.

### Advantageous Effects of Invention

According to the present invention, adjustment of a time/date of an assembly can be easily performed without causing a double booking. Switching between individual registration of a confirmed plan in a schedule of each of an adjustment initiator and an adjustment partner and integrated registration of both of the confirmed plan to be registered in the schedule of the adjustment initiator and the confirmed plan to be registered in the schedule of the adjustment partner in the schedule of the adjustment initiator can be easily performed depending on assembly details or belonging of the adjustment partner.

Problems, configurations, and effects other than those described above will become apparent in the following description of embodiments.

### BRIEF DESCRIPTION OF DRAWINGS

FIG. 1 is a diagram illustrating a configuration example of a time/date adjustment system according to one embodiment of the present invention.

FIG. 2 is a diagram illustrating an example of each of member information, user information, adjustment condition template information, and time/date adjustment information.

FIG. 3 is a sequence diagram for illustrating an example of processing performed by the time/date adjustment system at the time of member registration and use registration.

FIG. 4 is a sequence diagram for illustrating an example of same organization determination condition setting processing performed by the time/date adjustment system.

FIG. 5 is a diagram illustrating a display example of a same organization determination condition setting screen.

FIG. 6 is a sequence diagram for illustrating an example (customized adjustment) of time/date adjustment processing performed by the time/date adjustment system.

FIG. 7 is a diagram illustrating a display example of a condition setting screen.

FIG. 8 is a diagram illustrating a display example of a time/date editing screen.

FIG. 9 is a diagram illustrating a display example of a time/date adjustment screen.

FIG. 10 is a diagram illustrating a display example of a time/date confirmation screen.

FIG. 11 is a diagram illustrating an example of plan information to be registered in schedule information.

FIG. 12 is a diagram illustrating a display example of a time/date notification screen.

FIG. 13 is a diagram illustrating a display example of the time/date notification screen.

FIG. 14 is a sequence diagram for illustrating an example of adjustment condition template creation processing.

FIG. 15 is a diagram illustrating a display example of a template list screen.

FIG. 16 is a diagram illustrating a display example of a template creation screen.

FIG. 17 is a diagram illustrating a display example of the template creation screen.

FIG. 18 is a sequence diagram for illustrating another example (use adjustment condition template) of the time/date adjustment processing performed by the time/date adjustment system.

### DESCRIPTION OF EMBODIMENTS

One embodiment according to the present invention will be described below with reference to the drawings. Note that, in all the drawings for describing one embodiment, the same members are denoted by the same reference signs in principle, and repeated description thereof will be omitted. In the following embodiment, constituent elements (including element steps and the like) thereof are not necessarily essential, except for a case in which there is particular and explicit description, a case in which it is considered that those are obviously essential in principle, and the like. Concerning descriptions “to consist of A”, “to be composed of A”, “to have A”, and “to include A”, except for a case in which there is particular and explicit description that only the element is provided, and the like, elements other than the element are not to be excluded. Similarly, in the following embodiment, when there is a reference to a shape, a positional relationship, and the like of a constituent element and the like, a shape and the like that are substantially close to or similar to those shape and the like are included, except for a case in which there is particular and explicit description, a case in which it is considered that those are not obviously true in principle, and the like.

### Time/Date Adjustment System 10 according to One Embodiment of Present Invention

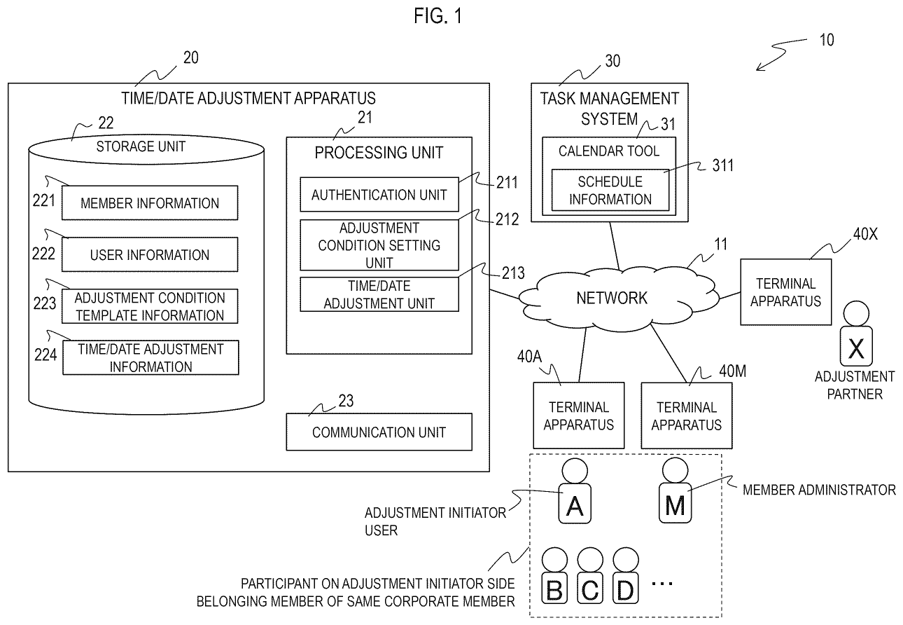

FIG. 1 illustrates a configuration example of a time/date adjustment system 10 according to one embodiment of the present invention.

The time/date adjustment system 10 is for assisting adjustment of a time/date of an assembly. The time/date adjustment system 10 includes a time/date adjustment apparatus 20, a task management system 30, and terminal apparatuses 40A, 40M, and 40X, which are connected via a network 11.

The network 11 is a two-way communication network, as typified by the Internet, a mobile phone communication network, and the like.

The time/date adjustment apparatus 20 performs adjustment of a time/date of an assembly with an adjustment partner X, in response to a request from an adjustment initiator A. Note that, as participants in the assembly, participant(s) on the adjustment initiator A side (one or more of the adjustment initiator A and the belonging members B, C, and D and the like (including a member administrator M of an organization to which the adjustment initiator A belongs) of an organization (a company or the like; a corporate member to be described later) to which the adjustment initiator A belongs) and participant(s) on the adjustment partner X side (which may be only the adjustment partner X or may be person(s) different from the adjustment partner X, and there are invariably one or more people, including a case in which there are a plurality of people) are assumed.

The task management system 30 includes a calendar tool 31 as a web application, is a system for to enhance efficiency of tasks or the like due to information sharing, plan management, or the like, and refers to a system that is widely provided for general consumers, self-employed people, corporations, and the like with or without a charge. As the calendar tool 31, for example, Google Calendar (trademark) and Microsoft Outlook (trademark) can be employed. The calendar tool 31 stores schedule information 311, in which action plans of a user of the calendar tool 31 and a booking status of assembly sites available to the user are registered. In other words, the task management system 30 manages schedule information 311, in which action plans of a user of the calendar tool 31 and a booking status of assembly sites available to the user are registered.

Note that, in a case of the present embodiment, the task management system 30 described as an external system independent of the time/date adjustment apparatus 20, but the task management system 30 may be present in the apparatus as the time/date adjustment apparatus 20. The calendar tool 31 may be included in the time/date adjustment apparatus 20. In other words, the calendar tool 31 managing the schedule information 311 may be present in a certain system, and the time/date adjustment apparatus 20 may refer to the schedule information 311 from the calendar tool 31.

The terminal apparatus 40A used by the adjustment initiator A includes a general computer, such as a personal computer and a smartphone, that can connect to the time/date adjustment apparatus 20 via the network 11. Similarly, the terminal apparatus 40M used by the member administrator M and the terminal apparatus 40X used by the adjustment partner X each include a general computer. The terminal apparatus 40A corresponds to a first terminal apparatus of the present invention, and the terminal apparatus 40X corresponds to a second terminal apparatus of the present invention.

The adjustment initiator A can designate one or a plurality of people out of the belonging members of the organization (corporate member to be described later) to which the adjustment initiator A belongs as participant(s) on the adjustment initiator A side in the assembly to perform time/date adjustment. A participant on the adjustment initiator A side is hereinafter referred to as an adjustment initiator-side participant. Similarly, a participant on the adjustment partner X side is referred to as an adjustment partner-side participant. The adjustment initiator-side participant may or may not include the adjustment initiator A themselves.

In the present embodiment, the adjustment partner X to participate in an assembly operates the terminal apparatus 40X; however, in actuality, a representative (a secretary or the like) of the adjustment partner X may operate the terminal apparatus 40X.

Moreover, in FIG. 1, only the adjustment partner X is illustrated as an adjustment partner to participate in an assembly; however, there may be a plurality of adjustment partners. In that case, the adjustment partner X or the representative (the secretary or the like) of the adjustment partner X may operate the terminal apparatus 40X on behalf of a plurality of adjustment partner-side participants.

The adjustment initiator A is a belonging member (an employee or the like) of a company or the like that has conducted member registration and use registration (registration of information necessary for making a time/date adjustment function in the time/date adjustment apparatus 20 available) with the time/date adjustment apparatus 20. The company or the like that has conducted member registration with the time/date adjustment apparatus 20 is hereinafter referred to as a corporate member. Among belonging members belonging to the corporate member (company or the like), a belonging member having a user account and having conducted use registration with the time/date adjustment apparatus 20 is defined as a user. It is essential that the adjustment initiator A be a user. Thus, the adjustment initiator A may be hereinafter referred to as a user A. Note that an individual, not a company or the like, can also conduct member registration and use registration with the time/date adjustment apparatus 20. In that case, the individual who has conducted member registration is referred to as an individual member. The individual member and the user can be regarded as the same, and the individual member can be regarded as equivalent to a corporate member in which the belonging member is only the individual member themselves and the user is only the individual member themselves.

The member administrator M is a belonging member of an organization being the same corporate member as the adjustment initiator A, and manages a member account as a corporate member. The adjustment initiator A and the member administrator M may be different persons, or may be the same person.

The belonging members B, C, D, and the like belonging to the same corporate member as the member administrator M and the adjustment initiator A, other than the adjustment initiator A, may be users, but this is not essential.

Belonging members belonging to the corporate member of the time/date adjustment apparatus 20 manage their plans, using the calendar tool 31 provided by the task management system 30. The corporate member of the time/date adjustment apparatus 20 manages the booking status of a meeting room, a reception room, a spare room, and the like available to the belonging members as an assembly site, using the calendar tool 31 provided by the task management system 30.

Thus, in the present case, the calendar tool 31 stores the schedule information 311 in which each of plans of the adjustment initiator A, the belonging members B, C, and D, and the like who may be adjustment initiator-side participants of an assembly and the booking status of assembly sites available to the adjustment initiator A and the like is registered.

Note that the adjustment partner X may be a user of the time/date adjustment apparatus 20, but this is not essential. The adjustment partner X may use the calendar tool 31, but this is not essential. The adjustment partner X may use a calendar tool provided by a vendor different from a vendor of the calendar tool 31 used by the adjustment initiator A. Note that, when the adjustment partner X belongs to the same organization (company or the like) as the adjustment initiator A, the following description will be given based on an assumption that the adjustment partner X also uses the calendar tool 31 of the same type as the one used by the adjustment initiator A. In other words, when the adjustment initiator A and the adjustment partner X belong to the same organization and both of the adjustment initiator A and the adjustment partner X are registered in an item of assembly participants of the plan on the calendar tool 31, the following description will be given based on an assumption that memo information of the plan and the like may be automatically shared between the adjustment initiator A and the adjustment partner X.

The time/date adjustment apparatus 20 includes functional blocks of a processing unit 21, a storage unit 22, and a communication unit 23. The time/date adjustment apparatus 20 includes a general computer such as a server computer including a processor such as a central processing unit (CPU), a memory such as a dynamic random access memory (DRAM), a storage such as a hard disk drive (HDD) and a solid state drive (SSD), an input device such as a keyboard, a mouse, and a touch panel, an output device such as a display, and a communication module such as a network interface card (NIC) (all of which are not illustrated).

The processing unit 21 is implemented by the processor of the computer. The processing unit 21 includes functional blocks of an authentication unit 211, an adjustment condition setting unit 212, and a time/date adjustment unit 213. These functional blocks are implemented by the processor of the computer executing a predetermined program loaded in the memory. Note that a part or all of these functional blocks may be implemented as hardware by an integrated circuit or the like.

For example, the authentication unit 211 receives member registration performed by the member administrator M using the terminal apparatus 40M, and creates member information 221. When the member administrator M logs in as the member administrator after generating the member information 221, for example, the authentication unit 211 performs authentication as the member administrator in response to the member administrator M logging in as the member administrator. For example, in response to a first login as a user performed by the adjustment initiator A using the terminal apparatus 40A, and when a predetermined condition (details will be described later) is satisfied, the authentication unit 211 creates user information 222.

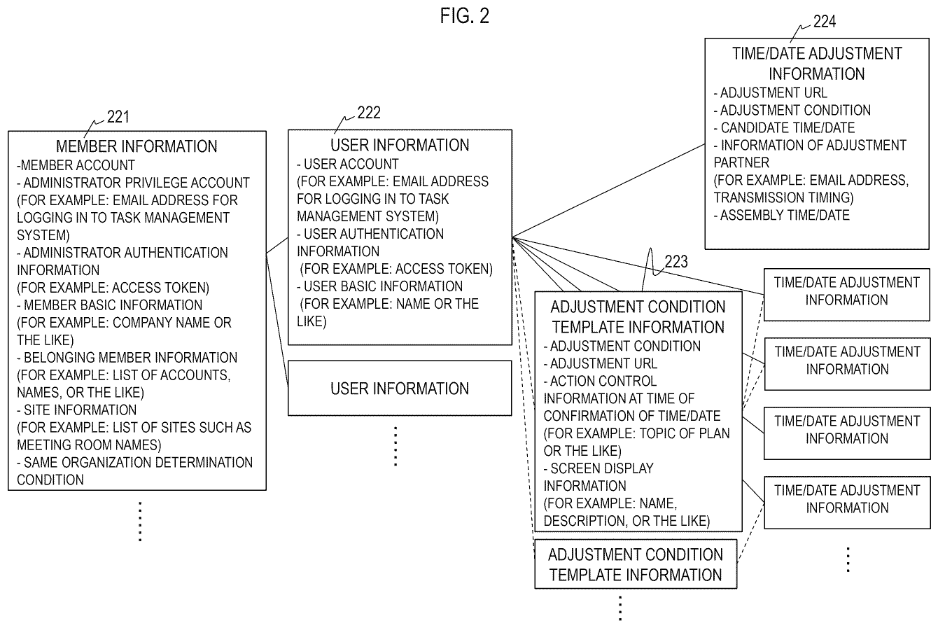

Moreover, the authentication unit 211 accesses the task management system 30 via the network 11, and for example, performs authentication processing in accordance with a protocol such as OAuth, using an administrator privilege account included in the member information 221 and a user account included in the user information 222 corresponding to the adjustment initiator A (user A) (both in FIG. 2) stored in the storage unit 22. Note that the administrator privilege account and the user account may be used in first authentication processing, and in second and following authentication processing, administrator authentication information (an access token or the like) and user authentication information (an access token or the like) (both in FIG. 2) transmitted from the task management system 30 after the first authentication processing has ended can be used.

The adjustment condition setting unit 212 causes the terminal apparatus 40A to display a condition setting screen for setting an adjustment condition including a plurality of items necessary for adjustment of a time/date of an assembly, sets the adjustment condition in response to an input from the adjustment initiator A on the condition setting screen, and registers results in time/date adjustment information 224 corresponding to the adjustment initiator A stored in the storage unit 22. The items of the adjustment condition will be described below.

The time/date adjustment unit 213 refers to the schedule information 311 of the adjustment initiator-side participants (which may or may not include the adjustment initiator A) of the assembly being managed by the calendar tool 31, and extracts available time/dates of the adjustment initiator-side participants satisfying the adjustment condition as first candidate time/dates. Then, the time/date adjustment unit 213 causes the terminal apparatus 40A to display a time/date editing screen for editing the first candidate time/dates, and determines second candidate time/dates in response to an editing operation from the adjustment initiator A on the time/date editing screen. The second candidate time/dates are registered in the time/date adjustment information 224 corresponding to the adjustment initiator A. When the first candidate time/dates are not edited by the adjustment initiator A, the second candidate time/dates are the same time/dates as the first candidate time/dates.

Note that, instead of determining the second candidate time/dates by editing the first candidate time/dates, extraction of the first candidate time/dates may be omitted, and for example, the adjustment initiator A may select dates and time and thereby determine the second candidate time/dates in the calendar on a predetermined screen that the time/date adjustment unit 213 causes the terminal apparatus 40A to display.

The time/date adjustment unit 213 issues an adjustment Uniform Resource Locator (URL) for the adjustment partner X to access a time/date adjustment screen. Note that, without the time/date adjustment unit 213 issuing the adjustment URL, the adjustment initiator A may designate the adjustment URL (details will be described below). The adjustment URL may be issued as text, or may be issued as an image such as a QR code (registered trademark). The issued adjustment URL is transmitted to the adjustment partner X by the adjustment initiator A, using an electronic mail or the like. The adjustment URL corresponds to access information of the present invention.

Moreover, when the adjustment partner X accesses the adjustment URL by using the terminal apparatus 40X, at that time point, the time/date adjustment unit 213 refers to the schedule information 311 of the adjustment initiator-side participants being managed by the calendar tool 31 again, and extracts third candidate time/dates that are available time/dates of the adjustment initiator-side participants satisfying the set adjustment condition and are within a range of the second candidate time/dates. Then, the time/date adjustment unit 213 causes the terminal apparatus 40X to display the time/date adjustment screen presenting the third candidate time/dates.

By extracting the third candidate time/dates, even if there is a change in the schedule of the adjustment initiator-side participants during time from when the adjustment URL is issued to when the adjustment partner X accesses the adjustment URL, occurrence of a double booking due to such a change can be suppressed.

Note that the schedule of the adjustment initiator-side participants may change even during a short period of time until the adjustment partner X selects the assembly time/date out of the third candidate time/dates displayed on the time/date adjustment screen and confirms the assembly time/date on the time/date confirmation screen. Thus, the time/date adjustment unit 213 performs final check that the selected assembly time/date is an available time/date of the adjustment initiator-side participants satisfying the adjustment condition, immediately before the assembly time/date is confirmed on the time/date confirmation screen. Then, if the selected assembly time/date is no longer an available time/date of the adjustment initiator-side participants satisfying the adjustment condition, for example, a message such as “The designated time has been occupied. Select again” may be displayed on the terminal apparatus 40X, and the operation may be returned back to the time/date adjustment screen. With this configuration, occurrence of a double booking can be further suppressed.

Moreover, the time/date adjustment unit 213 confirms the assembly time/date that has been determined by the adjustment partner X and has been successfully subjected to final check, and registers the plan related to the confirmed assembly time/date in the schedule information 311 of the adjustment initiator-side participants. Then, the confirmed assembly time/date and the like are registered in the time/date adjustment information 224 corresponding to the adjustment initiator A, which is stored by the storage unit 22.

Note that, regarding registration of the plan in the schedule information 311, whether or not to add the adjustment partner-side participants to the item of the assembly participants in the plan to be registered is determined first (a determination method will be described later), and then the plan is registered in the schedule information 311 of the adjustment initiator-side participants (the adjustment initiator A may or may not be included in the participants; the adjustment initiator A when the adjustment initiator A is included in the participants, and one of the adjustment initiator-side participants when the adjustment initiator A is not included in the participants) managed by the calendar tool 31.

When the time/date adjustment unit 213 determines not to add the adjustment partner-side participants to the item of the assembly participants, the time/date adjustment unit 213 registers the plan in the schedule information 311 of the adjustment initiator-side participants (the adjustment initiator A may or may not be included in the participants; the adjustment initiator A when the adjustment initiator A is included in the participants, and one of the adjustment initiator-side participants when the adjustment initiator A is not included in the participants) managed by the calendar tool 31, with only the adjustment initiator-side participants being designated as the item of the assembly participants in the plan to be registered.

Note that to designate a participant as an item of the assembly participants in the plan of the schedule information 311 means to record an identifier, such as a user account and an email address, that allows for identification of the user in the calendar tool 31 in the item of the assembly participants of the plan. With this configuration, the registered plan can be reflected in the schedule information 311 of each participant on the adjustment initiator A side managed by the calendar tool 31. When the adjustment initiator A or the like edits the memo information or the like of the plan registered in the schedule information 311 of the adjustment initiator-side participants, the edited details are shared only among the adjustment initiator-side participants. Note that, in this case, the adjustment partner X needs to individually register the confirmed plan of the assembly in the schedule of the adjustment partner X (when there are a plurality of adjustment partner-side participants, the adjustment partner X needs to include all of the plurality of adjustment partner-side participants in the item of the assembly participants of the plan individually registered by the adjustment partner X).

In contrast, when the time/date adjustment unit 213 determines to add the adjustment partner-side participants to the assembly participants, the time/date adjustment unit 213 registers the plan in the schedule information 311 of the adjustment initiator-side participants (the adjustment initiator A may or may not be included in the participants; the adjustment initiator A when the adjustment initiator A is included in the participants, and one of the adjustment initiator-side participants when the adjustment initiator A is not included in the participants) managed by the calendar tool 31, with the adjustment initiator-side participants and the adjustment partner-side participants being designated as the item of the assembly participants in the plan to be registered. In this case, the plan registered in the adjustment initiator A is also shared with the adjustment partner-side participants, and when the adjustment initiator A or the like edits the memo information or the like of the plan registered in the schedule information 311, the edited details are shared not only with the adjustment initiator-side participants but also with the adjustment partner-side participants.

The storage unit 22 is implemented by the memory and the storage of the computer. The storage unit 22 stores the member information 221, the user information 222, adjustment condition template information 223, and the time/date adjustment information 224. Note that the storage unit 22 may store information, data, and the like other than the various pieces of information described above.

The communication unit 23 is implemented by the communication module of the computer. The communication unit 23 connects to the task management system 30, the terminal apparatuses 40A, 40M, and 40X, and the like via the network 11 and communicates various pieces of data and information therewith.

Note that a part or all of the above-described functional blocks constituting the time/date adjustment apparatus 20 may be implemented by hardware such as an integrated circuit. The time/date adjustment apparatus 20 may be implemented by a plurality of computers, and in that case, the above-described functional blocks may be distributedly deployed in the plurality of computers.

Next, FIG. 2 illustrates an example of the member information 221, the user information 222, the adjustment condition template information 223, and the time/date adjustment information 224 stored in the storage unit 22.

The member information 221 includes information related to a corporate member that has conducted member registration with the time/date adjustment apparatus 20. The member information 221 includes information related to a corporate member to be added through use registration of the corporate member with the time/date adjustment apparatus 20. Specifically, the member information 221 includes a member account, an administrator privilege account, administrator authentication information, member basic information, belonging member information, site information, and a same organization determination condition.

The member account is information for the member administrator M or the like of the corporate member (company or the like) to log in to the time/date adjustment apparatus 20. The administrator privilege account is information for the member administrator M or the like of the corporate member (company or the like) to access the task management system 30 by using the administrator privileges in the task management system 30. Note that the member account may be common to or different from the administrator privilege account (for example, an email address of the member administrator M or the like). When the member account and the administrator privilege account are common to each other, registration of the administrator privilege account with the member information 221 may be omitted.

The administrator authentication information is an access token or the like that is obtained from the task management system 30 as success results of the authentication processing when the authentication unit 211 of the time/date adjustment apparatus 20 performs the authentication processing with the task management system 30 for the first time, using the administrator privilege account. After the administrator authentication information is obtained, the authentication unit 211 can more promptly perform the authentication processing with the task management system 30 by using the administrator authentication information, without using the administrator privilege account.

The member basic information is a name of the corporate member (a company name or the like) or the like. The member basic information is recorded at the time of member registration, and can also be changed after the member registration. The belonging member information is a list of names and email addresses of belonging members belonging to the corporate member (company or the like), user accounts for identifying the belonging members in the task management system 30, and the like. The belonging member information is acquired from the task management system 30 and then recorded on an assumption that the belonging members of the corporate member who may be adjustment initiator-side participants already use the calendar tool 31.

The site information is a list of names of sites, such as a meeting room, a reception room, and a spare room, available to the belonging members belonging to the corporate member for an assembly, IDs for identifying the sites in the task management system 30, and the like. The site information is acquired from the task management system 30 and then recorded on an assumption that the schedules of the sites necessary for time/date adjustment are already managed by the calendar tool 31.

Note that the belonging member information and the site information are information that can be partially or entirely acquired from the task management system 30 only when the task management system 30 is accessed using the administrator privilege account, and for example, cannot be acquired when an account not having the administrator privileges is used instead of the administrator privilege account or when the task management system 30 is accessed using an account that has privileges equivalent to the administrator privilege account but is used as a user account (it is to be noted that the information can be partially or entirely acquired in some cases even when the account not having the administrator privileges is used, depending on a type of the task management system 30).

The same organization determination condition is a condition for an assembly participant on the adjustment partner X side to determine whether or not the assembly participant belongs to the same organization as the adjustment initiator A (details will be described later).

The user information 222 includes information related to a user who has conducted use registration of the time/date adjustment apparatus 20 among the belonging members belonging to the corporate member. The user information 222 is created when each user logs in to the time/date adjustment apparatus 20 for the first time, succeeds in the authentication processing with the task management system 30, and it is confirmed that the user is included in the belonging member information of the member information 221, and is then associated with the member information 221.

The user information 222 includes a user account, user authentication information, and user basic information.

The user account is information for the user, such as the adjustment initiator A, to log in to the time/date adjustment apparatus 20. The user account is desirably common to, but may be different from, an account for the user to access the task management system 30. The following description will be given based on an assumption that the user account is common to an account for accessing the task management system 30.

The user authentication information is an access token or the like that is obtained from the task management system 30 as success results of the authentication processing when the authentication unit 211 performs the authentication processing with the task management system 30 for the first time, using the user account. After the user authentication information is obtained, the authentication unit 211 can more promptly perform the authentication processing with the task management system 30, using the user authentication information, without using the user account.

The user basic information is a name of the user or the like, and is read from the belonging member information of the member information 221 based on the user account used by the user in logging in to the time/date adjustment apparatus 20 for the first time, and is then recorded. The user basic information recorded in the user information 222 may be able to be edited by the user themselves.

The adjustment condition template information 223 includes an adjustment condition, an adjustment URL, action control information (a topic and the like of a plan to be registered in the schedule information 311 of the adjustment initiator-side participant) at the time of confirmation of a time/date, and screen display information (a name (for example, “for a first interview for recruitment of a new graduate” and the like), a description, and the like of an adjustment condition template), which are designated by the user in advance depending on a purpose of the assembly.

Note that the adjustment condition template information 223 is created by the user and thus the adjustment condition template information 223 is associated with the user information 222; however, for example, the adjustment condition template information 223 may be associated with the member information 221, such that the adjustment condition template information 223 may be shared between users belonging to the corporate member corresponding to the member information 221. An adjustment condition template created by one user may be used by another user.

The time/date adjustment information 224 is created in association with the user information 222 corresponding to each user for each assembly in which the user is the adjustment initiator. Note that, considering that a user different from the user who has created the adjustment condition template adjusts a time/date using the adjustment condition template, the time/date adjustment information 224 may be directly associated with the member information 221 of a corporate member to which the user belongs.

In the time/date adjustment information 224, the adjustment URL, the adjustment condition, the candidate time/dates (the second candidate time/dates), information (an email address, a timing of transmitting a notification email, and the like) of the adjustment partner, a confirmed date and time of the assembly, and the like are recorded.

### Processing Performed by Time/Date Adjustment System 10 at Time of Member Registration and Use Registration

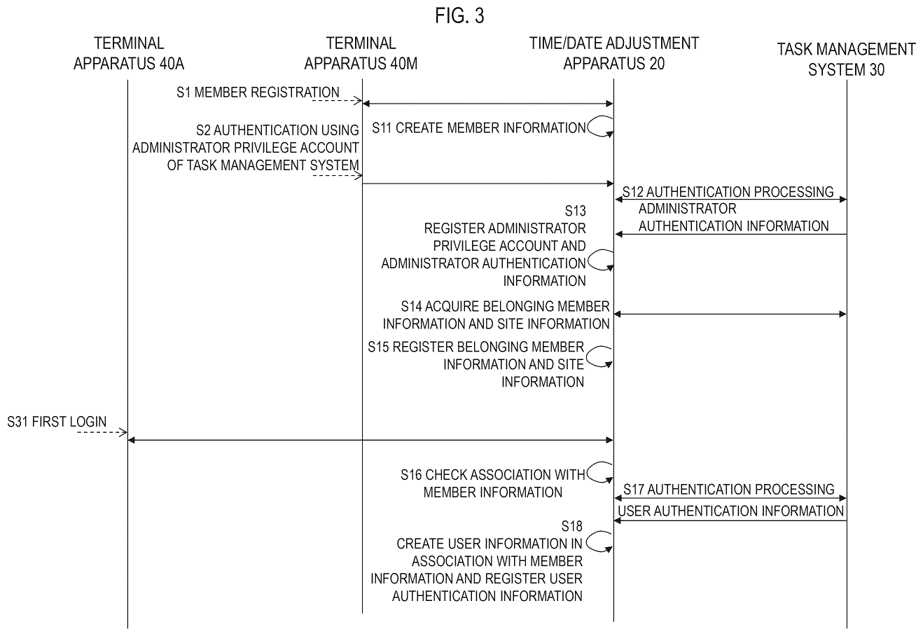

Next, FIG. 3 is a sequence diagram for illustrating an example of processing performed by the time/date adjustment system 10 at the time of member registration and use registration.

As an assumption, the calendar tool 31 provided by the task management system 30 is used for management of plans of the belonging members of the corporate member to which the adjustment initiator A and the member administrator M belong and availability of the assembly sites, and the task management system 30 already manages the belonging member information and the site information recorded in the member information 221. Further, the task management system 30 supplies, as its specifications, at least one of the belonging member information and the site information recorded in the member information 221 to the time/date adjustment apparatus 20, in response to a request from the time/date adjustment apparatus 20 accessed using the administrator privilege account (or the administrator authentication information).

First of all, when the member administrator M requests member registration with the time/date adjustment apparatus 20 via the network 11 by using the terminal apparatus 40M (Step S1), the authentication unit 211 of the time/date adjustment apparatus 20 creates the member information 221 and records the member information 221 in the storage unit 22 (Step S11). Note that, here, the created member information 221 includes only the member account and the member basic information, and does not include the administrator privilege account, the administrator authentication information, the belonging member information, and the site information.

Next, when the member administrator M inputs the administrator privilege account in the task management system 30 to the time/date adjustment apparatus 20 and requests the authentication processing with the time/date adjustment apparatus 20 (Step S2), next, the authentication unit 211 performs the authentication processing with the task management system 30, using the administrator privilege account (Step S12).

Note that, as a modification, Steps S1 and S11 may be executed after execution of Steps S2 and S12.

Then, the administrator authentication information (access token or the like) is transmitted from the task management system 30 to the time/date adjustment apparatus 20 as success results of the authentication processing of Step S12, and thus, next, the authentication unit 211 registers the administrator privilege account and the administrator authentication information in the member information 221 created and recorded in Step S11 (Step S13). Note that, for the authentication processing, OAuth can be used, for example, and by having the member administrator M input a password to the task management system 30 temporarily without using the authentication unit 211, the administrator privilege account input by the member administrator M is authenticated by the task management system 30. The same holds true for the authentication processing performed by other persons such as the adjustment initiator A.

Next, the authentication unit 211 connects to the task management system 30 by using the administrator authentication information of the member information 221, and acquires the belonging member information and the site information of the corporate member to which the member administrator M belongs, which are managed by the task management system 30 (Step S14). Next, the authentication unit 211 registers the belonging member information and the site information acquired in Step S14 in the member information 221 created and recorded in Step S11 (Step S15).

Subsequently, when the adjustment initiator A uses the user account of the adjustment initiator A and logs in to the time/date adjustment apparatus 20 via the network 11 for the first time, using the terminal apparatus 40A (Step S31), the authentication unit 211 of the time/date adjustment apparatus 20 checks presence of the member information 221 in which the belonging member information including the user account of the adjustment initiator A is registered, and acquires the name (user basic information) of the adjustment initiator A and the like from the belonging member information (Step S16). Next, the authentication unit 211 performs the authentication processing with the task management system 30, using the user account of the adjustment initiator A (Step S17).

Then, the user authentication information (access token or the like) is transmitted from the task management system 30 to the time/date adjustment apparatus 20 as success results of the authentication processing of Step S17, and thus, next, the authentication unit 211 creates the user information 222 corresponding to the adjustment initiator A, records the user information 222 in the storage unit 22 in association with the member information 221 checked in Step S16, and registers the user account and the user authentication information of the adjustment initiator A and the user basic information acquired in Step S16 in the user information 222 (Step S18). Through the above processing, the processing at the time of member registration and use registration ends.

According to the processing at the time of member registration and use registration described above, in the time/date adjustment apparatus 20, the member information 221 of the corporate member to which the adjustment initiator A belongs and the user information 222 of the adjustment initiator A are associated with each other, and the time/date adjustment apparatus 20 stores the user authentication information for the task management system 30 of the adjustment initiator A. Thus, after the processing, even when the adjustment initiator A being a user is not logged in to the time/date adjustment apparatus 20, for example, the time/date adjustment unit 213 of the time/date adjustment apparatus 20 can refer to and update the schedule information 311 in which action plans of the adjustment initiator A and the belonging members B, C, and D and the like belonging to the same corporate member as the adjustment initiator A are registered and the schedule information 311 in which plans of assembly sites (a meeting room and the like) available to the adjustment initiator A and the belonging members B, C, and D and the like belonging to the same corporate member as the adjustment initiator A are registered, which are stored in the task management system 30, via a web application programming interface (API).

Note that, in the processing at the time of member registration and use registration described above, the user information of the user belonging to the corporate member is generated, on an assumption that the member information 221 of the corporate member is present. As a modification, when an organization to which a certain individual belongs is not the corporate member and the member information 221 thereof is thus not present, the certain individual may log in to the time/date adjustment apparatus 20 and create the user information 222, and the individual may subsequently perform anew the authentication processing with the task management system 30 by using the administrator privilege account, and the member information 221 associated with the individual may be thereby generated based on the user information 222 of the individual, with the individual being regarded as the corporate member and a user account of the individual being regarded as a member account. In this case, the individual as the corporate member has the administrator privilege account, and can thus acquire the belonging member information and the site information of the organization to which the individual belongs from the task management system 30.

In the present embodiment, the belonging member information and the site information acquired from the task management system 30 are registered in the member information 221 stored in the storage unit 22; however, without the belonging member information and the site information being registered in the member information 221, the belonging member information and the site information may be acquired from the task management system 30 every time the pieces of information need to be referred to.

In the present embodiment, the belonging member information and the site information are acquired using the administrator privilege account on the task management system 30; however, when it is difficult to use the administrator privilege account of the task management system 30 from the perspective of security and the like, the belonging member information and the site information may be directly registered with the time/date adjustment apparatus 20 without using the administrator privilege account on the task management system 30. For example, the member administrator M or the user of the corporate member may directly register the belonging member information and the site information with the time/date adjustment apparatus 20 by uploading data, such as an Excel (trademark) file, recording the belonging member information and the site information with the time/date adjustment apparatus 20, directly inputting the data on a screen for use registration displayed on the terminal apparatus 40M or the terminal apparatus 40A by the time/date adjustment apparatus 20, or the like. By using the user account privileges of the member administrator M or the user of the corporate member without using the administrator privilege account, only the belonging member information and the site information that can be acquired from the task management system 30 may be acquired from the task management system 30 and registered with the time/date adjustment apparatus 20.

In the present embodiment, the belonging member information is acquired by using the administrator privilege account on the task management system 30; however, a plurality of users who have performed use registration as individual members may be aggregated, all of the aggregated users may be regarded as users belonging to one corporate member to form the member information 221 and the user information 222, and information of such an aggregated user group may be formed as the belonging member information of the corporate member. For example, a user who has performed use registration as an individual member may, as a person belonging to the same organization as the user, establish an invitation relationship among users by inviting another user who has registered with the time/date adjustment apparatus 20 or by inviting a person who has not registered with the time/date adjustment apparatus 20 and having the person perform use registration with the time/date adjustment apparatus 20, and thereby form an aggregation of users.

### Same Organization Determination Condition Setting Processing Performed by Time/Date Adjustment System 10

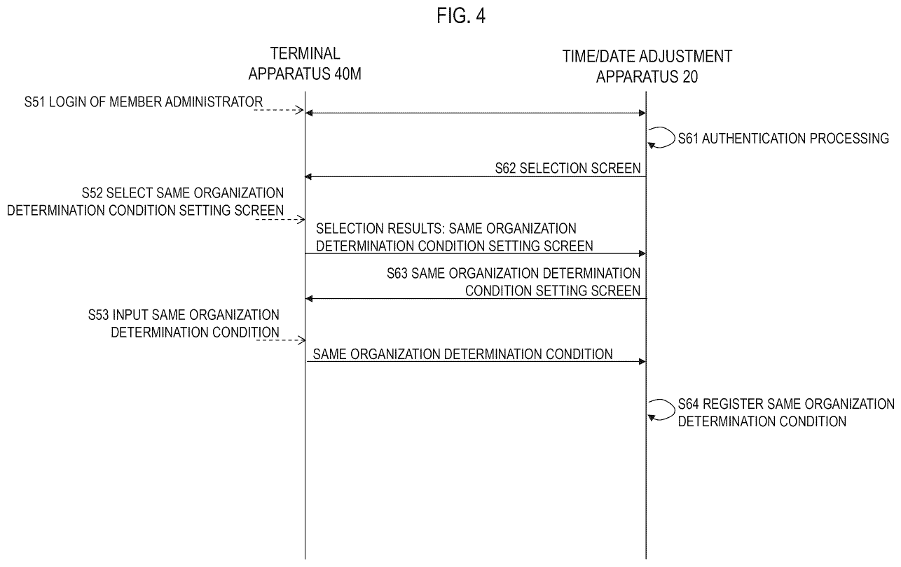

Next, FIG. 4 is a sequence diagram for illustrating an example of same organization determination condition setting processing performed by the time/date adjustment system 10.

First of all, when the member administrator M logs in to the time/date adjustment apparatus 20 via the network 11 as the member administrator by using the terminal apparatus 40M (Step S51), in response to the login of the member administrator M, the authentication unit 211 of the time/date adjustment apparatus 20 performs the authentication processing in the time/date adjustment apparatus 20 by using the member account included in the member information 221 corresponding to the member administrator M stored by the storage unit 22 (Step S61).

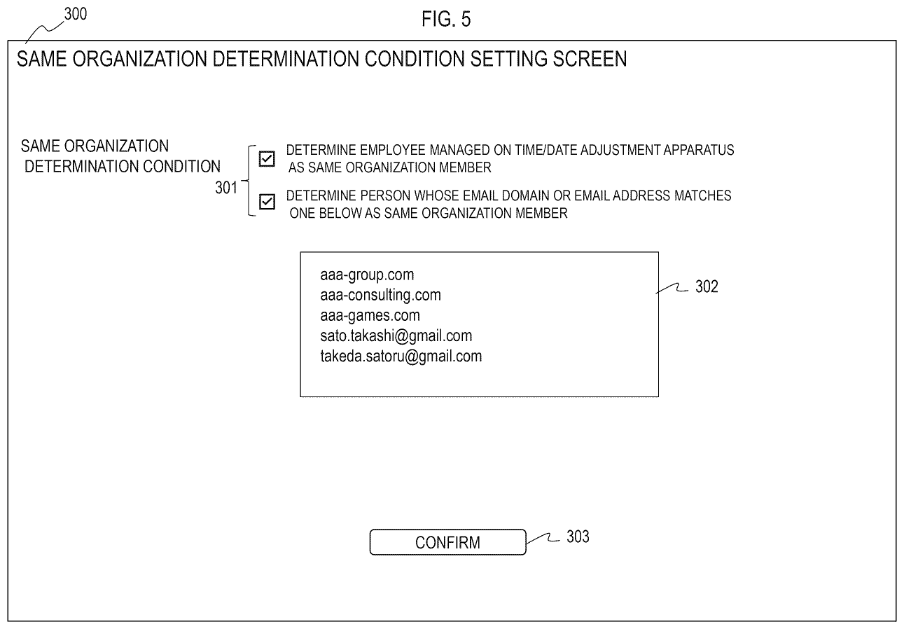

Next, the adjustment condition setting unit 212 of the time/date adjustment apparatus 20 causes the terminal apparatus 40M to display a selection screen (not illustrated) for selecting various operations as the member administrator (Step S62). Next, on the selection screen, when the member administrator M selects a same organization determination condition setting screen (Step S52), next, the adjustment condition setting unit 212 of the time/date adjustment apparatus 20 causes the terminal apparatus 40M to display a same organization determination condition setting screen 300 (FIG. 5) for setting the same organization determination condition (Step S63).

FIG. 5 is a display example of the same organization determination condition setting screen 300 displayed in the terminal apparatus 40M. The same organization determination condition setting screen 300 is provided with a check box 301 for selecting “determine employee managed on time/date adjustment apparatus as same organization member” and “determine person whose email domain or email address matches one below as same organization member” as the same organization determination condition, an input field 302 for designating the email domain and the email address when “determine person whose email domain or email address matches one below as same organization member” is selected in the check box 301, and a “confirm” button 303 for confirming the input setting value.

Note that, regarding settings of the item of the same organization determination condition to be selected in the check box 301, only “determine employee managed on time/date adjustment apparatus as same organization member” is selected as an initial value.

The same organization determination condition is a setting value for determining whether or not the adjustment partner X is a person belonging to the same organization as the adjustment initiator A when the time/date is confirmed in time/date adjustment, and is used by the time/date adjustment unit 213 as one determination criterion in determining whether or not to add the adjustment partner-side participants to the item of the assembly participants in the plan to be registered in the schedule information 311. Note that the determination method will be described later in detail.

FIG. 4 is referred to again. When the member administrator M sets the same organization determination condition and performs operation on the “confirm” button 303 on the same organization determination condition setting screen 300 displayed in the terminal apparatus 40M (Step S53), in response to the operation, the adjustment condition setting unit 212 of the time/date adjustment apparatus 20 registers the designated same organization determination condition in the member information 221 of the member administrator M (Step S64).

In the present case, for example, as illustrated in FIG. 5, the following description will be given based on an assumption that both of “determine employee managed on time/date adjustment apparatus as same organization member” and “determine person whose email domain or email address matches one below as same organization member” are selected in the check box 301 as the same organization determination condition, and five values of “aaa-group.com”, “aaa-consulting.com”, “aaa-games.com”, “sato.takashi@gmail.com”, and “takeda.satoru@gmail.com” are input to the input field 302.

Note that, in the present embodiment, in order to give simple description using separate functions, the same organization determination condition setting processing (FIG. 4) is described separately from the processing at the time of use registration (FIG. 3); however, it is desirable that the same organization determination condition be set before the user (the adjustment initiator A or the like) starts time/date adjustment operation. Thus, it is desirable that the same organization determination condition setting processing (FIG. 4) be performed in a flow of the series of use registration processing of the corporate member performed by the member administrator M after Step S15 and before Step S31 of FIG. 3.

In the present embodiment, the same organization determination condition is set by the member administrator M; however, the user (the adjustment initiator A or the like) granted the privileges to be allowed to perform operation on the same organization determination condition setting screen 300 may be allowed to perform operation on the same organization determination condition setting screen 300 and set the same organization determination condition.

Furthermore, in the present embodiment, owing to the member administrator M setting the same organization determination condition, the same organization determination condition is an item that can be designated for each member; however, it may be arranged that the same organization determination condition can be designated for each user. Note that, when it is arranged that the same organization determination condition can be designated for each user, regarding a setting value designated for each user, the designated setting value may be inherited for each member and the inherited setting value may be able to be changed by each user. Note that, when the same organization determination condition is set for each user, the setting value for each user is prioritized over the setting value for each member. Note that the same organization determination condition designated for each user may be registered in the user information 222 being information for each user, instead of the member information 221.

### Time/Date Adjustment Processing Performed by Time/Date Adjustment System 10

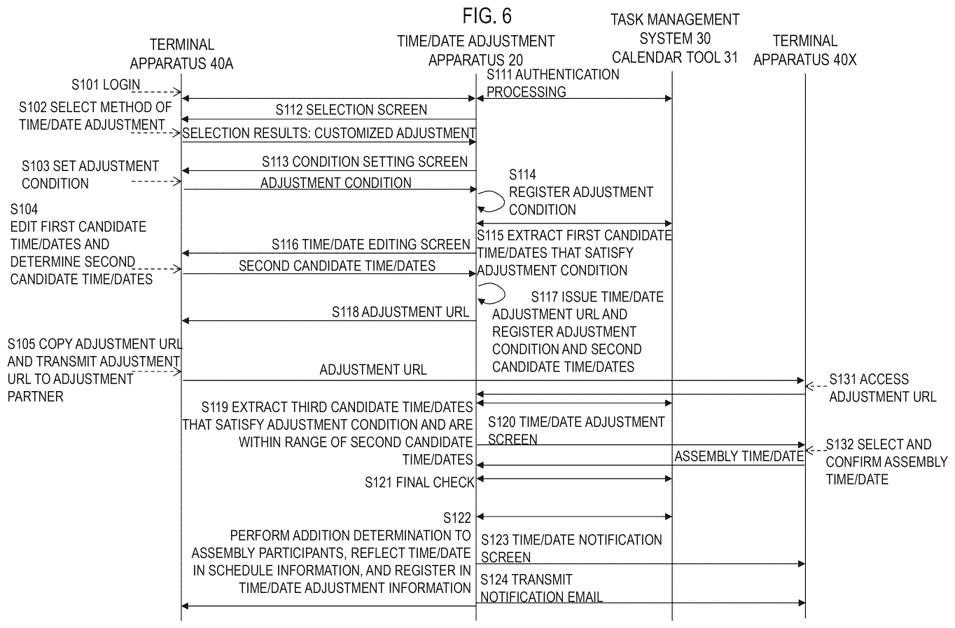

Next, FIG. 6 is a sequence diagram for illustrating an example of time/date adjustment processing performed by the time/date adjustment system 10.

First of all, the adjustment initiator A logs in to the time/date adjustment apparatus 20 via the network 11, using the terminal apparatus 40A (Step S101). Then, in response to the login of the adjustment initiator A, the authentication unit 211 of the time/date adjustment apparatus 20 performs the authentication processing with the task management system 30, using the user account (or the user authentication information) included in the user information 222 corresponding to the adjustment initiator A stored by the storage unit 22 (Step S111).

Next, the adjustment condition setting unit 212 of the time/date adjustment apparatus 20 causes the terminal apparatus 40A to display a selection screen (not illustrated) for selecting either “customized adjustment” or “use template” as a method of time/date adjustment (Step S112). Next, on the selection screen, the adjustment initiator A selects the method of time/date adjustment (Step S102). In the present case, description will be given based on an assumption that the adjustment initiator A selects customized adjustment.

### Case in Which “Customized Adjustment” is Selected as Method of Time/Date Adjustment

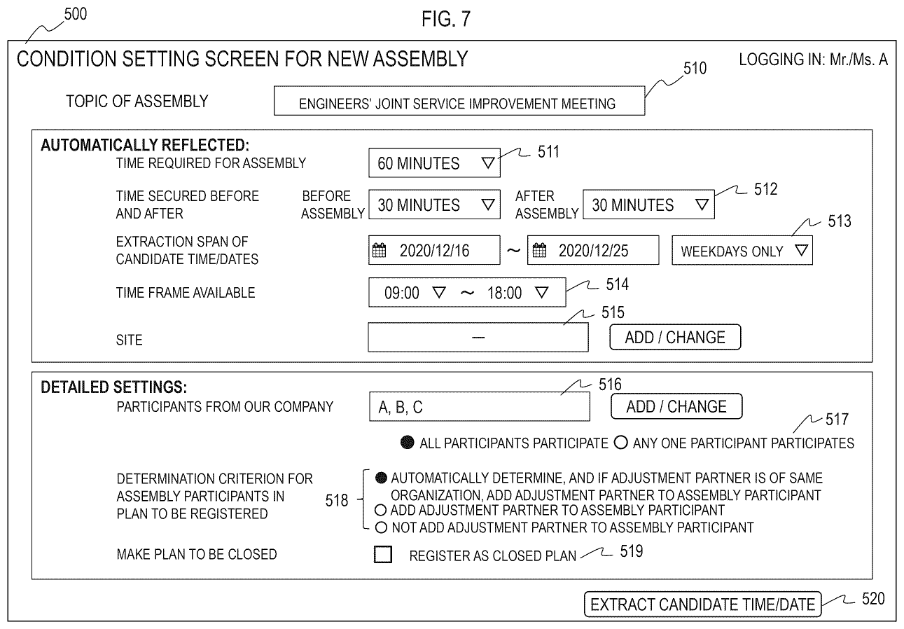

Next, the adjustment condition setting unit 212 of the time/date adjustment apparatus 20 causes the terminal apparatus 40A to display a condition setting screen 500 (FIG. 7) for setting an adjustment condition (Step S113).

FIG. 7 is a display example of the condition setting screen 500 displayed in the terminal apparatus 40A. The condition setting screen 500 is provided with an input field 510 for inputting a topic of an assembly, a selection input field 511 for inputting time required for the assembly, a selection input field 512 for inputting time secured before and after the assembly, a selection input field 513 for inputting an extraction span of the candidate time/dates (a selection input field for designating the extraction span of the candidate time/dates with a date, month, and year and a selection input field for target day(s) for automatically extracting the candidate time/dates within the designated span (weekdays only, including Saturday, Sunday, and a national holiday, or the like)), a selection input field 514 for inputting a time frame available for the assembly, and a selection input field 515 for selecting and designating one or more sites (meeting rooms or the like) to be used for the assembly out of a site list based on the site information of the member information 221. Here, the time secured before and after the assembly is time for movement to the site, preparation work, withdrawal work, a break, and the like.

Note that, in display of the selection input fields 511 to 515, contents of the adjustment condition of the most recent assembly where the adjustment initiator A is the adjustment initiator are reflected with reference to the time/date adjustment information 224 associated with the user information 222 corresponding to the adjustment initiator A. With this configuration, time and efforts taken by the adjustment initiator A to input the adjustment condition can be reduced. Note that whether or not to allow automatic reflection of the adjustment condition of the most recent assembly in the selection input fields 511 to 515 may be selected by designation of the adjustment initiator A. One or more patterns for adjustment conditions may be registered in advance, so that when one of the patterns is designated and invoked, a corresponding adjustment condition can be simply reflected. The adjustment condition (information other than the extraction span of the candidate time/dates) of the adjustment condition template information 223 already registered may be copied, so that the adjustment condition can be simply reflected.

Furthermore, the condition setting screen 500 is provided with a selection input field 516 for selecting and designating one or more adjustment initiator-side participants (which may or may not include the adjustment initiator A) out of a belonging member list based on the belonging member information of the member information 221, a radio button 517 for selecting an assembly participation condition of the adjustment initiator-side participant(s) designated in the selection input field 516, a radio button 518 for selecting and designating a determination criterion as to whether or not to add the adjustment partner-side participants to the item of the assembly participants in the plan of the assembly to be registered in the schedule information 311 of the adjustment initiator-side participant(s), a check box 519 for selecting whether or not to register the plan of the assembly as a closed plan, and an “extract candidate time/date” button 520 for confirming each input item and instructing extraction of candidate time/dates of the assembly.

In the radio button 518, one of “automatically determine, and if adjustment partner is of same organization, add adjustment partner to assembly participant”, “add adjustment partner to assembly participant”, and “not include adjustment partner in assembly participant” can be selected as the determination criterion. Note that the radio button 518 may be omitted, and the determination criterion may be fixed to “automatically determine, and if adjustment partner is of same organization, add adjustment partner to assembly participant”.

Note that, when a plurality of people are designated as the adjustment initiator-side participants in the selection input field 516 and all of the designated adjustment initiator-side participants need to participate in the assembly, “all participants participate” may be selected in the radio button 517. When a plurality of people are designated as the adjustment initiator-side participants in the selection input field 516 and it is sufficient that at least one of the designated adjustment initiator-side participants participates, “any one participant participates” may be selected in the radio button 517. When only one adjustment initiator-side participant is input in the selection input field 516, “all participants participate” is automatically selected in the radio button 517, whereas when there is only one participant, subsequent operations, such as extraction of candidate time/dates, are all the same, regardless of whether “all participants participate” or “any one participant participates” is selected.

When a plurality of people are input to the selection input field 516 as the adjustment initiator-side participants and “all participants participate” is selected in the radio button 517, the schedule information 311 of all of the adjustment initiator-side participants is referred to, and available time/dates common to all of the adjustment initiator-side participants satisfying the adjustment condition are extracted as the candidate time/dates. In contrast, when a plurality of people are input to the selection input field 516 on the condition setting screen 500 as the adjustment initiator-side participants and “any one participant participates” is selected in the radio button 517, the schedule information 311 of all of the adjustment initiator-side participants is referred to, and available time/dates of at least one of all of the adjustment initiator-side participants satisfying the adjustment condition are extracted as the first candidate time/dates. The same holds true for cases in which the second and third candidate time/dates are extracted, which will be described below.

FIG. 6 is referred to again. When the adjustment initiator A inputs each item of the adjustment condition and performs operation on the “extract candidate time/date” button 520 on the condition setting screen 500 displayed in the terminal apparatus 40A (Step S103), in response to the operation, the adjustment condition setting unit 212 of the time/date adjustment apparatus 20 creates new time/date adjustment information 224 in association with the user information 222 of the adjustment initiator A and causes the storage unit 22 to store the time/date adjustment information 224, and registers the set adjustment condition in the time/date adjustment information 224 (Step S114).

In the present case, the following description will be given based on an assumption that, for example, as illustrated in FIG. 7, as the adjustment condition, the topic of the assembly is set to “engineers' joint service improvement meeting”, the time required for the assembly is set to “60 minutes”, the time secured before and after the assembly is each set to “30 minutes”, the extraction span of the candidate time/dates is set to “weekdays only” from “Dec. 16, 2020” to “Dec. 25, 2020”, the time frame available is set to “09:00 to 18:00”, the site is set to “not designated”, the input of adjustment initiator-side participants is set to three persons of “A, B, and C”, the assembly participation condition of the input adjustment initiator-side participants is set to “all participants participate”, the assembly participants in the plan to be registered are set to “automatically determine, and if adjustment partner is of same organization, add adjustment partner to assembly participant”, and registration of the plan of the assembly is set to “open to public”.

Next, the time/date adjustment unit 213 reads the adjustment condition registered in the time/date adjustment information 224 associated with the adjustment initiator A from the storage unit 22, refers to the schedule information 311 of the adjustment initiator-side participants managed by the calendar tool 31 of the task management system 30, and extracts available time/dates of the adjustment initiator-side participants satisfying the adjustment condition at the current time point as the first candidate time/dates (Step S115).

Specifically, in the present case, time that is available time/dates common to the adjustment initiator-side participants A, B, and C, a time frame from 09:00 to 18:00 on weekdays from Dec. 16, 2020 to Dec. 25, 2020, and in which 60 minutes as the time required for the assembly can be secured is extracted, and further, time in which 30 minutes as the time secured before the assembly and 30 minutes as the time secured after the assembly cannot be secured is excluded, and the first candidate time/dates are thereby determined.

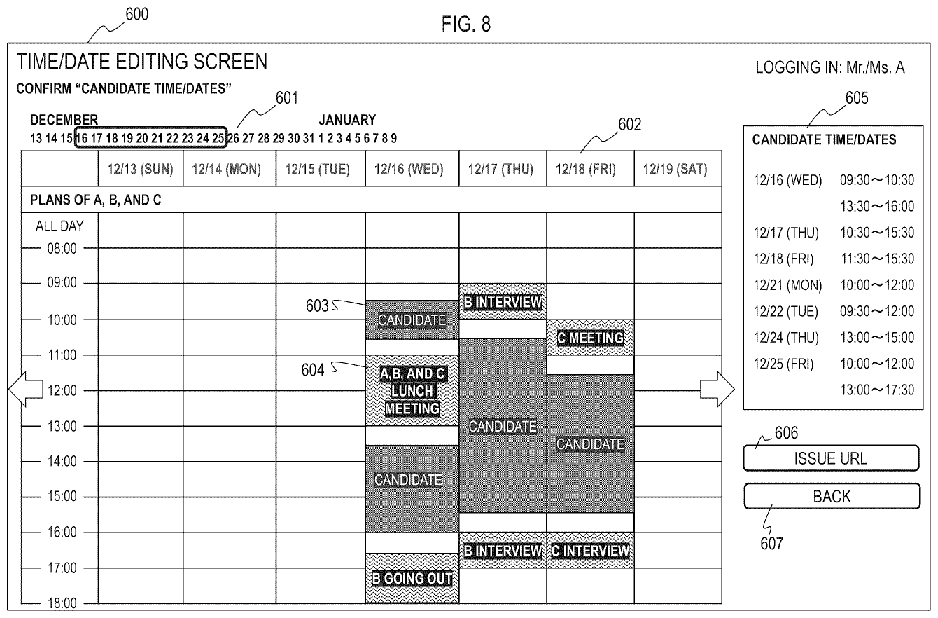

Next, the time/date adjustment unit 213 causes the terminal apparatus 40A to display a time/date editing screen 600 (FIG. 8) presenting the first candidate time/dates (Step S116).

FIG. 8 illustrates a display example of the time/date editing screen 600 displayed in the terminal apparatus 40A. On the time/date editing screen 600, a candidate time/date span frame 601, a calendar 602 displayed in a grid pattern with its horizontal axis representing dates and vertical axis representing time, and a candidate time/date list 605 in which the first candidate time/dates are listed per day are displayed. On the time/date editing screen 600, an “issue URL” button 606 and a “back” button 607 are provided.

The candidate time/date span frame 601 indicates a span including the first candidate time/dates out of the extraction span of the candidate time/dates input to the selection input field 513 of the condition setting screen 500 (FIG. 7).

On the calendar 602, based on the schedule information 311 of the adjustment initiator-side participants managed by the calendar tool 31, existing plan frames 604 indicating respective plans of all of the adjustment initiator-side participants within a display span on the calendar 602 and first candidate time/date frames 603 are displayed in different colors or the like so that the existing plan frames 604 and the first candidate time/date frames 603 can be distinguished from each other. With this configuration, the adjustment initiator A can edit the first candidate time/dates while checking existing plans of the adjustment initiator-side participants. Note that, when there are a plurality of adjustment initiator-side participants, names of the participants may be displayed in the existing plan frames 604, or the existing plan frames 604 may be assigned different colors, so as to allow making a distinction as to whose existing plan a plan is out of the plurality of participants.

In the candidate time/date list 605, the first candidate time/dates are listed and displayed per day.

The adjustment initiator A can edit (extend, shorten, partially exclude, entirely exclude) the first candidate time/dates, by using a pop-up screen (not illustrated) to be displayed by selecting the first candidate time/date frame 603 in the calendar 602. For example, on the pop-up screen displayed by selecting a frame of 10:30 to 15:30 on December 17th (Thursday), 10:30 being the starting time and 15:30 being the ending time of the frame may be set to earlier or later time. A part of the frame, for example, 12:00 to 13:00 on the day, can be excluded from the first candidate time/dates, and the entire frame (entire frame of the 10:30 to 15:30) can be excluded from the first candidate time/dates. The editing results of the first candidate time/dates in the calendar 602 are immediately reflected in the candidate time/date list 605. Note that editing of the first candidate time/dates may be performed with an operation, such as drag and drop, on the screen, depending on an operation of an input device (a mouse, a touch panel, or the like) provided for the terminal apparatus 40A. The same holds true for other screen operations in the terminal apparatuses 40A and 40X.

Note that the adjustment initiator A can edit the first candidate time/dates also in the candidate time/date list 605.

The “issue URL” button 606 is a button for confirming the editing results (second candidate time/dates) of the first candidate time/dates by the adjustment initiator A in the calendar 602 and instructing issuing of the adjustment URL for the adjustment partner X to access the time/date adjustment screen. The “back” button 607 is a button for returning back to the condition setting screen 500.

In the present case, the following description will be given based on an assumption that the adjustment initiator A excludes 15:00 to 16:00 on December 16th (Wednesday) from the first candidate time/dates on the time/date editing screen 600.

FIG. 6 is referred to again. When the adjustment initiator A edits the first candidate time/dates as necessary and performs operation on the “issue URL” button 606 on the time/date editing screen 600 displayed in the terminal apparatus 40A (Step S104), next, the time/date adjustment unit 213 of the time/date adjustment apparatus 20 issues the adjustment URL, and registers the adjustment URL and the second candidate time/dates in the time/date adjustment information 224 (created in Step S114) corresponding to the adjustment initiator A (Step S117).

Next, the time/date adjustment unit 213 causes the terminal apparatus 40A to display the issued adjustment URL and a message for instructing transmission of the adjustment URL to the adjustment partner (not illustrated) (Step S118).

Next, in response to the message, the adjustment initiator A copies the adjustment URL displayed in the terminal apparatus 40A, pastes the adjustment URL to an electronic mail or the like, and transmits the adjustment URL to the terminal apparatus 40X of the adjustment partner X (Step S105). Note that, as a modification, the adjustment initiator A may be caused to input the email address and the like of the adjustment partner X as a transmission destination of the adjustment URL in advance, and the time/date adjustment unit 213 may automatically transmit electronic mail or the like including the adjustment URL to the adjustment partner X.

Next, when the adjustment partner X who has received the adjustment URL accesses the adjustment URL using the terminal apparatus 40X (Step S131), the time/date adjustment unit 213 of the time/date adjustment apparatus 20 reads the adjustment condition and the second candidate time/dates registered in the time/date adjustment information 224 of the adjustment initiator A corresponding to the adjustment URL from the storage unit 22, refers to the schedule information 311 of the adjustment initiator-side participants managed by the calendar tool 31, and extracts the third candidate time/dates that are available time/dates of the adjustment initiator-side participants satisfying the adjustment condition at the current time point and are within a range of the second candidate time/dates (Step S119).

In the present case, it is assumed that a plan at 13:00 to 14:00 on December 17th (Thursday) is added to the schedule information 311 of the adjustment initiator A being an adjustment initiator-side participant during time from when the adjustment URL is issued to when the adjustment partner X accesses the adjustment URL. In this case, the third candidate time/dates are those obtained by excluding, from the second candidate time/dates, 12:30 to 14:30 on December 17th (Thursday) with “30 minutes” as the time secured before and after the assembly being taken into consideration. In other words, the “time secured before and after” of the adjustment condition is also applied to the additional plan of the adjustment initiator A.

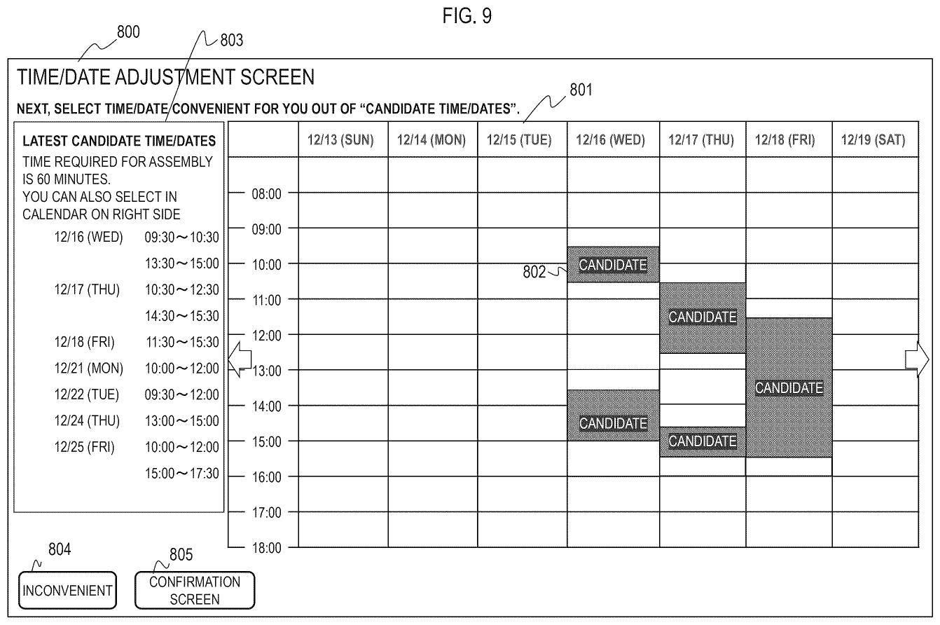

Next, the time/date adjustment unit 213 causes the terminal apparatus 40X to display a time/date adjustment screen 800 (FIG. 9) (Step S120).

FIG. 9 illustrates a display example of the time/date adjustment screen 800. On the time/date adjustment screen 800, a calendar 801 displayed in a grid pattern with its horizontal axis representing dates and vertical axis representing time and a candidate time/date list 803 in which the third candidate time/dates are listed per day are displayed. On the time/date adjustment screen 800, an “inconvenient” button 804 and a “confirmation screen” button 805 are provided.

In the calendar 801, third candidate time/date frames 802 are displayed in different colors or the like so that the third candidate time/date frames 802 can be distinguished from other frames. Note that, in the calendar 801, existing plans of the adjustment initiator-side participants are not displayed, unlike the calendar 602 of the time/date editing screen 600 (FIG. 8). Thus, for the adjustment partner X, privacy of the adjustment initiator-side participants can be protected.

In the candidate time/date list 803, the time required for the assembly and the third candidate time/dates listed per day are displayed.

The adjustment partner X can select the assembly time/date by selecting one of the third candidate time/date frames 802 in the calendar 801. Note that, when a frame longer than “60 minutes” as the time required for the assembly is selected, a pop-up screen (not illustrated) is displayed. The adjustment partner X can determine the assembly time/date by selecting the time “60 minutes” as the time required within the selected frame on the pop-up screen.

In the present case, the following description will be given based on an assumption that the adjustment partner X determines 11:00 to 12:00 on December 17th (Thursday) as the assembly time/date on the time/date adjustment screen 800.

The “inconvenient” button 804 is a button on which operation is performed when the third candidate time/dates presented on the time/date adjustment screen 800 are inconvenient for the adjustment partner X. When the adjustment partner X performs operation on the “inconvenient” button 804, the adjustment initiator A is notified that suggested candidate time/dates are inconvenient. In this case, the adjustment initiator A changes the adjustment condition, and executes the time/date adjustment processing again.

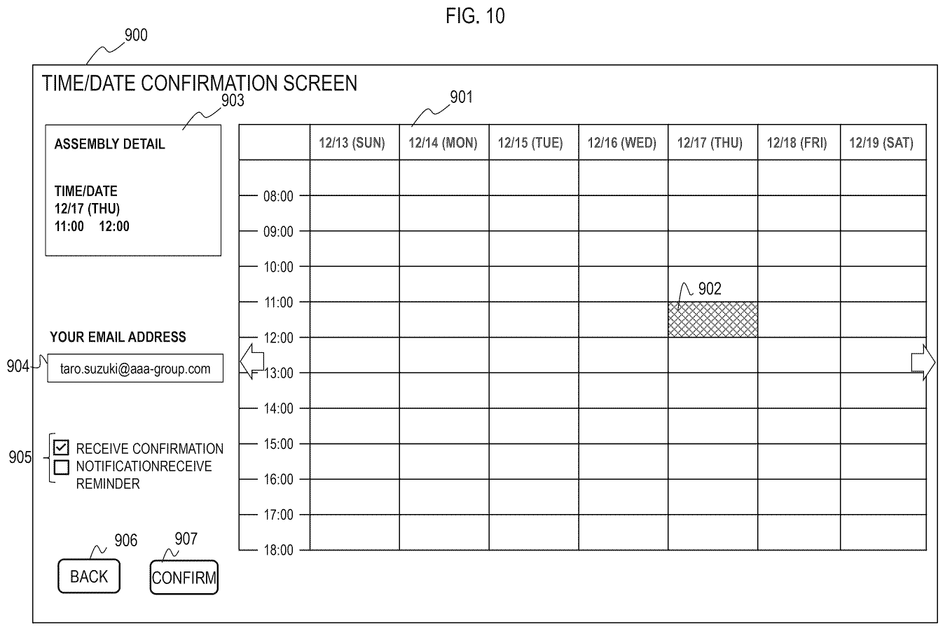

The “confirmation screen” button 805 is a button for checking with the determined assembly time/date. When the adjustment partner X performs operation on the “confirmation screen” button 805, the time/date confirmation screen 900 (FIG. 10) for the adjustment partner X themselves to confirm with the assembly time/date selected and determined out of the third candidate time/dates is displayed in the terminal apparatus 40X.

FIG. 10 illustrates a display example of the time/date confirmation screen 900. On the time/date confirmation screen 900, a calendar 901 displayed in a grid pattern with its horizontal axis representing dates and vertical axis representing time and an assembly detail 903 are displayed.

In the calendar 901, an assembly time/date frame 902 selected and determined on the time/date adjustment screen 800 (FIG. 9) by the adjustment partner X themselves is displayed in different colors or the like so that the assembly time/date frame 902 can be distinguished from other frames. In the assembly detail 903, the selected and determined assembly time/date (in the present case, 11:00 to 12:00 on December 17th (Thursday) ) is displayed.

The time/date confirmation screen 900 is provided with an input field 904 for the adjustment partner X to input an email address of the adjustment partner X, a check box 905 for setting a timing of transmitting a notification email for giving notification of holding of the assembly for the adjustment partner X, a “back” button 906 for returning back to the time/date adjustment screen 800, and a “confirm” button 907 for confirming the contents displayed on the time/date confirmation screen 900.

In the present case, the following description will be given based on an assumption that the adjustment partner X inputs “taro.suzuki@aaa-group.com” in the input field 904 on the time/date confirmation screen 900.

Note that, in the present embodiment, only the email address of the adjustment partner X is input in the input field 904 on an assumption that only the adjustment partner X is to be an adjustment partner-side participant; however, a plurality of email addresses of adjustment partner-side participants may be able to be input in the input field 904 on an assumption of a case in which there are a plurality of adjustment partner-side participants. In that case, the display name of the item of the input field 904 may be changed so that the adjustment partner X can know that a plurality of email addresses of adjustment partner-side participants can be input. A notification destination email address for performing notification of the assembly time/date may be input in an item separate from the email addresses for identifying the adjustment partner-side participants.

FIG. 6 is referred to again. When the adjustment partner X inputs the email address of the adjustment partner X to the input field 904 and performs operation on the “confirm” button 907 on the time/date confirmation screen 900 (FIG. 10) displayed in the terminal apparatus 40X (Step S132), the time/date adjustment unit 213 refers to the schedule information 311 of the adjustment initiator-side participants managed by the calendar tool 31, and performs final check that the assembly time/date confirmed on the time/date confirmation screen 900 is an available time/date of the adjustment initiator-side participants satisfying the adjustment condition at the current time point (Step S121). Here, when the confirmed assembly time/date is no longer an available time/date of the adjustment initiator-side participants satisfying the adjustment condition because a plan is made by an adjustment initiator-side participant, for example, a message such as “The designated time has been occupied. Select again” may be displayed on the terminal apparatus 40X, and the processing may be brought back to Step S119 and may resume from the operation of the adjustment partner X on the time/date adjustment screen 800.

In the final check of Step S121, when the final check is successfully performed that the confirmed assembly time/date is an available time/date of the adjustment initiator-side participants satisfying the adjustment condition, the time/date adjustment unit 213 registers the confirmed plan of the assembly with the adjustment partner X in the schedule information 311 of the adjustment initiator-side participants managed by the calendar tool 31, and further registers the email address of the adjustment partner X, the timing of transmitting the notification email, the date and time of the assembly, and the like in the time/date adjustment information 224 (created in Step S114) corresponding to the adjustment initiator A, which is stored in the storage unit 22 (Step S122).

Note that, regarding registration of the plan in the schedule information 311, whether or not to add the adjustment partner X to the item of the assembly participants in the plan to be registered is determined first, and then the plan is registered in the schedule information 311 of the adjustment initiator A (one of the adjustment initiator-side participants when the adjustment initiator A is not a participant) managed by the calendar tool 31.

When the adjustment initiator A selects “automatically determine, and if adjustment partner is of same organization, add adjustment partner to assembly participant” in the radio button 518 on the condition setting screen 500 (FIG. 7), the time/date adjustment unit 213 determines whether or not the adjustment partner X is a member belonging to the same organization as the adjustment initiator A (the determination is hereinafter referred to as “same organization determination”) based on the setting value of the same organization determination condition set by the member administrator M on the same organization determination condition setting screen 300 (FIG. 5) and the email address of the adjustment partner X input by the adjustment partner X in the input field 904 on the time/date confirmation screen 900 (FIG. 10), and determines whether or not to add the adjustment partner X to the item of the assembly participants in the plan to be registered (the determination is hereinafter referred to as “addition determination to the assembly participants”) based on results of the same organization determination.

Specifically, when the member administrator M selects the option “determine employee managed on time/date adjustment apparatus as same organization member” on the same organization determination condition setting screen 300 (FIG. 5), whether or not the email address of the adjustment partner X is present in the belonging member information managed in the member information 221 of the corporate member to which the adjustment initiator A belongs is checked, and when the presence is checked, it is determined that the adjustment partner X is a “member belonging to the same organization” as the adjustment initiator A as the same organization determination. Then, when the “member belonging to the same organization” is determined as the same organization determination, the plan of the assembly is registered, with the adjustment partner X being added to the adjustment initiator-side participants in the item of the assembly participants in the plan to be registered. When the member administrator M selects the option “determine person whose email domain or email address matches one below as same organization member” on the same organization determination condition setting screen 300 (FIG. 5), whether or not the email domain or the email address of the adjustment partner X matches one of the email domains or the email addresses designated in the input field 302 on the same organization determination condition setting screen 300 (FIG. 5) is checked, and when the matching is checked, it is determined that the adjustment partner X is a “member belonging to the same organization” as the adjustment initiator A as the same organization determination. Then, when the “member belonging to the same organization” is determined as the same organization determination, the plan of the assembly is registered, with the adjustment partner X being added to the adjustment initiator-side participants in the item of the assembly participants in the plan to be registered. When the email address of the adjustment partner X does not fall into either of the above two patterns, the adjustment partner X is not regarded as the same organization member as the adjustment initiator A, and the plan of the assembly is registered, with the adjustment partner-side participants not being added and only the adjustment initiator-side participants being set in the item of the assembly participants in the plan to be registered.

Note that, when email addresses of a plurality of people as the adjustment partner-side participants can be input in the input field 904 on the time/date confirmation screen 900 (FIG. 10), the above-described same organization determination may be performed on a part or all of the email addresses out of the plurality of input email addresses, and whether or not to add a part or all of the adjustment partner-side participants to the item of the assembly participants in the plan to be registered may be determined by using the results of the same organization determination.

Specifically, for example, when the above-described same organization determination is performed by using the email address input at the beginning out of the email addresses of the plurality of people input by the adjustment partner X and the email address is successfully determined to be of a “member belonging to the same organization” as the adjustment initiator A, all of the adjustment partner-side participants may be added to the item of the assembly participants. Alternatively, when the above-described same organization determination is performed on all of the email addresses of the adjustment partner-side participants and one or more email addresses of the adjustment partner-side participants are successfully determined to be of “member(s) belonging to the same organization” as the adjustment initiator A, all of the adjustment partner-side participants may be added to the item of the assembly participants. Alternatively, only when the above-described same organization determination is performed on all of the email addresses of the adjustment partner-side participants and all of the email addresses of the adjustment partner-side participants are successfully determined to be of “members belonging to the same organization” as the adjustment initiator A, all of the adjustment partner-side participants may be added to the item of the assembly participants. Alternatively, the above-described same organization determination may be performed for each email address of the adjustment partner-side participants, and only the email address(es) successfully determined to be of “member(s) belonging to the same organization” as the adjustment initiator A may be added to the item of the assembly participants.

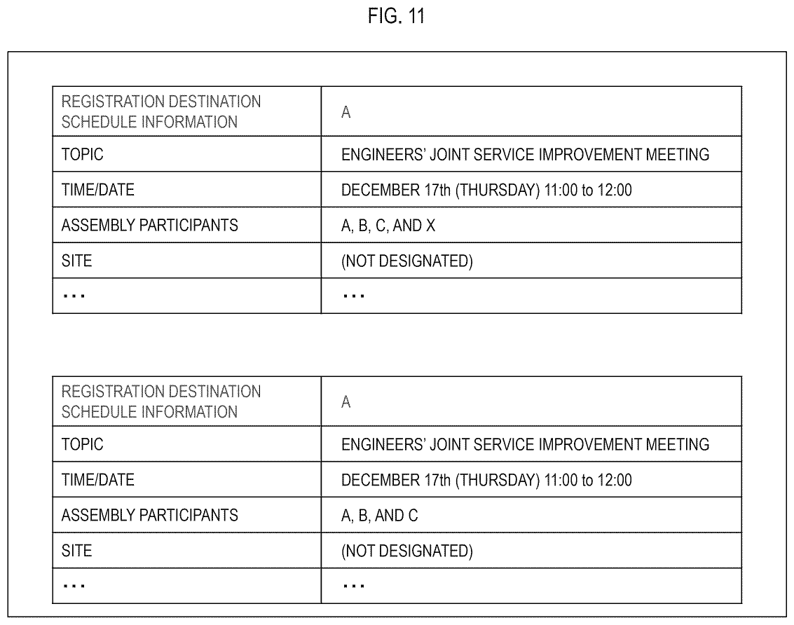

Next, FIG. 11 illustrates an example of the plan information to be registered in the schedule information 311 when the time/date adjustment unit 213 registers the confirmed plan of the assembly in the schedule information 311 of the adjustment initiator A. Note that, in a general calendar tool, in registration of one assembly plan, even when a plurality of people are assembly participants, the plan may be registered only in the schedule information 311 of any one of the people, and the registered plan is reflected in all the schedule information such as the schedule information as the registration destination and the schedule information of members designated as the item of the assembly participants.

The upper part of FIG. 11 is an example of the plan information corresponding to a case in which the adjustment partner X being an adjustment partner-side participant is included in the item of the assembly participants in the plan to be registered as a result of the addition determination to the assembly participants. In the item of the assembly participants of the plan information, the adjustment partner X being an adjustment partner-side participant is added to the adjustment initiator-side participants A, B, and C. The lower part of FIG. 11 is an example of the plan information corresponding to a case in which the adjustment partner X being an adjustment partner-side participant is not included in the item of the assembly participants in the plan to be registered as a result of the addition determination to the assembly participants. In the item of the assembly participants of the plan information, the adjustment initiator-side participants A, B, and C are registered, and the adjustment partner X being an adjustment partner-side participant is not added. Note that the difference between the plan information in the upper part of FIG. 11 and the plan information in the lower part of FIG. 11 is only a difference regarding whether or not the adjustment partner X is added to the item of the assembly participants, and settings of the rest of the items are all the same.

For example, when the adjustment initiator A selects “add adjustment partner to assembly participant” in the radio button 518 on the condition setting screen 500 (FIG. 7), regardless of the email address of the adjustment partner X, the time/date adjustment unit 213 registers the plan of the assembly, with the adjustment partner X (including all of the plurality of participants on the adjustment partner X side, when a plurality of people can be designated as the adjustment partner-side participants) being added to the adjustment initiator-side participants in the item of the assembly participants in the plan to be registered.

Furthermore, for example, when the adjustment initiator A selects “not add adjustment partner to assembly participant” in the radio button 518 on the condition setting screen 500 (FIG. 7), regardless of the email address of the adjustment partner X, the time/date adjustment unit 213 registers the plan of the assembly, with the adjustment partner X (including all of the plurality of participants on the adjustment partner X side, when a plurality of people can be designated as the adjustment partner-side participants) not being added and only the adjustment initiator-side participants being set in the item of the assembly participants in the plan to be registered.

In the present case, three persons of A, B, and C are designated as the adjustment initiator-side participants in the selection input field 516 on the condition setting screen 500 (FIG. 7), and “all participants participate” is selected in the radio button 517. In the radio button 518 on the condition setting screen 500 (FIG. 7), “automatically determine, and if adjustment partner is of same organization, add adjustment partner to assembly participant” is selected. Furthermore, both of the options of “determine employee managed on time/date adjustment apparatus as same organization member” and “determine person whose email domain or email address matches one below as same organization member” are selected in the check box 301 on the same organization determination condition setting screen 300 (FIG. 5), and five values of “aaa-group.com”, “aaa-consulting.com”, “aaa-games.com”, “sato.takashi@gmail.com”, and “takeda.satoru@gmail.com” are designated in the input field 302 for designating the email domains and the email addresses. Furthermore, in the input field 904 on the time/date confirmation screen 900 (FIG. 10), “taro.suzuki@aaa-group.com” is designated as the email address of the adjustment partner X.

Then, “aaa-group.com” being an email domain of the adjustment partner X matches the email domain designated in the input field 302 on the same organization determination condition setting screen 300 (FIG. 5), and thus as a result of the same organization determination, the adjustment partner X is determined to be a “member belonging to the same organization” as the adjustment initiator A, and as a result, also in the addition determination to the assembly participants, “add adjustment partner-side participant” is determined as the item of the assembly participants in the plan to be registered. In other words, the time/date adjustment unit 213 registers the plan of the assembly in the schedule information 311 of the adjustment initiator A managed by the calendar tool 31, with the adjustment initiator-side participants A, B, and C and “taro.suzuki@aaa-group.com” for identifying the adjustment partner X being designated as the item of the assembly participants in the plan to be registered.

Note that, when “any one participant participates” is selected in the radio button 517 on the condition setting screen 500 (FIG. 7), only one person being a person for which the confirmed assembly time/date is an available time/date satisfying the adjustment condition is selected out of the adjustment initiator-side participants A, B, and C input to the selection input field 516, and only the one selected person is regarded as the adjustment initiator-side participant, and thus the one selected person on the adjustment initiator side and the adjustment partner X are designated as the item of the assembly participants in the plan to be registered.

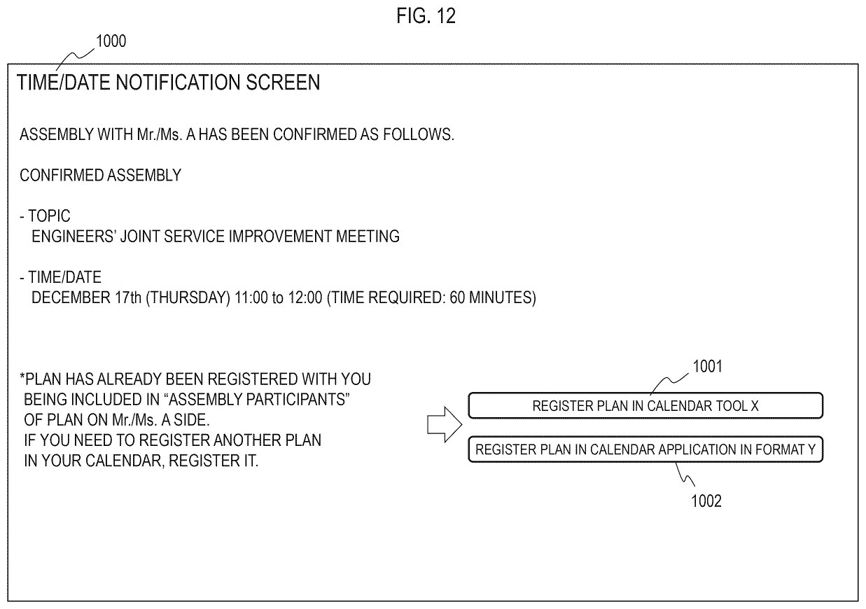

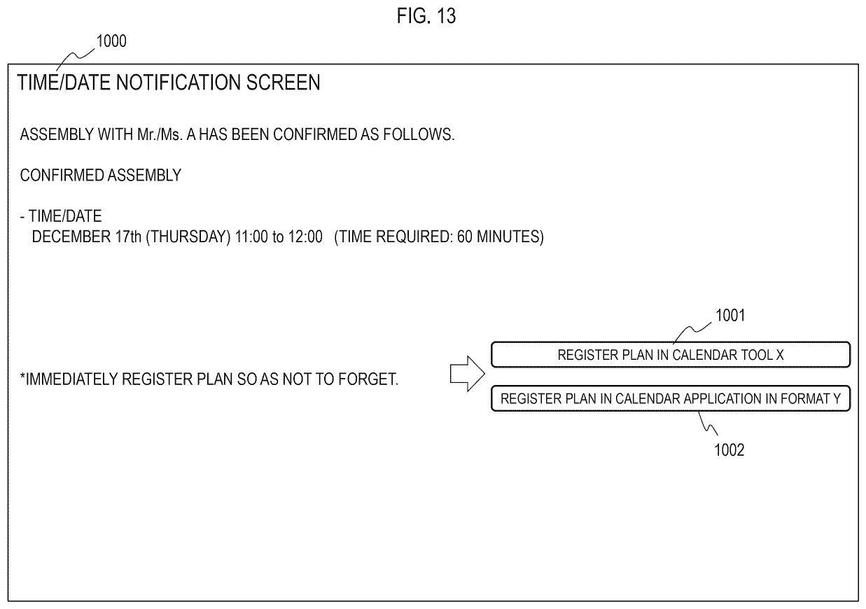

FIG. 6 is referred to again. Next, the time/date adjustment unit 213 displays a time/date notification screen 1000 (FIG. 12 or FIG. 13) presenting the time/date of the assembly confirmed by the adjustment partner X themselves and the like in the terminal apparatus 40X (Step S123).

FIG. 12 illustrates a display example of the time/date notification screen 1000 when the assembly plan is registered with the adjustment partner X being an adjustment partner-side participant being added to the item of the assembly participants of the plan. On the time/date notification screen 1000, the confirmed time/date of the assembly and the like are displayed. The time/date notification screen 1000 is provided with a registration button 1001 for the plan for a specific type of calendar tool and a registration button 1002 for the plan for a schedule application using a certain prescribed data format. The adjustment partner X performs operation on the registration button 1001 or the registration button 1002 depending on a type of the calendar tool used by the adjustment partner X, and can thereby register the confirmed plan of the assembly in the calendar tool used by the adjustment partner X as the plan of the adjustment partner X themselves. Note that, when the adjustment partner uses the calendar tool 31 of the same type as the adjustment initiator A, the plan of the assembly is already reflected in the schedule information 311 of the adjustment partner X, and thus in principle, the adjustment partner X need not perform operation on the registration buttons 1001 and 1002. Note that, in the radio button 518 on the condition setting screen 500 (FIG. 7), when the adjustment initiator A selects “add adjustment partner to assembly participant”, and registers the plan of the assembly with the adjustment partner X being forcibly added to the item of the assembly participants in the plan to be registered regardless of belonging of the adjustment partner X, the plan of the assembly is not necessarily reflected in the calendar tool used by the adjustment partner X, and thus the time/date notification screen 1000 (FIG. 12) is provided with the registration buttons 1001 and 1002 in a complementary sense.

Note that, in the present embodiment, whether or not to add the adjustment partner-side participants to the item of the assembly participants of the plan to be registered in the schedule information 311 of the adjustment initiator-side participants is determined based on the settings on the adjustment initiator A side and the email addresses input by the adjustment partner X; however, whether or not to add the adjustment partner-side participants to the item of the assembly participants of the plan of the adjustment initiator-side participants may be able to be designated by the adjustment partner X. Specifically, for example, the time/date confirmation screen 900 (FIG. 10) is provided with an option (not illustrated), such as a check box, for the adjustment partner X to select whether or not to add the adjustment partner-side participants to the item of the assembly participants of the plan of the adjustment initiator-side participants. When the adjustment partner X selects an option of not to add the adjustment partner-side participants to the item of the assembly participants of the plan of the adjustment initiator-side participants, the addition determination to the assembly participants performed by the time/date adjustment unit 213 is omitted (the same processing as that when “not add adjustment partner to assembly participant” is selected in the radio button 518 on the condition setting screen 500 (FIG. 7) is performed). Note that the option (not illustrated), such as a check box, for the adjustment partner X to select whether or not to add the adjustment partner-side participants to the item of the assembly participants of the plan of the adjustment initiator-side participants may be provided only when it is determined to “add adjustment partner-side participant” to the item of the assembly participants in the plan to be registered as a result of the addition determination to the assembly participants.

FIG. 13 illustrates a display example of the time/date notification screen 1000 when the assembly plan is registered with the adjustment partner X being an adjustment partner-side participant being not added to the item of the assembly participants of the plan. The registration buttons 1001 and 1002 are the same as those of FIG. 12, and thus description will be omitted. When the adjustment partner X is not added to the item of the assembly participants of the plan, the plan of the assembly is not reflected in the calendar tool used by the adjustment partner X, and thus the adjustment partner X needs to register the plan in the calendar tool of the adjustment partner x by performing operation on the registration button 1001 or the registration button 1002 or by directly registering the plan in the calendar tool used by the adjustment partner X.

FIG. 6 is referred to again. Next, the time/date adjustment unit 213 transmits a notification email for performing notification of holding of the assembly including the determined assembly time/date to the adjustment initiator-side participants and the adjustment partner X (the email address designated by the adjustment partner X in the input field 904 on the time/date confirmation screen 900 (FIG. 10); when a plurality of email addresses as the adjustment partner-side participants can be input, all of the email addresses) (Step S124). Note that transmission of the notification email to the adjustment partner X is performed not only at a timing when the adjustment partner X themselves confirms the assembly time/date but also at a later timing according to a transmission timing selected by the adjustment partner X themselves.

Note that, in the present embodiment, an arrow from the time/date adjustment apparatus 20 to the terminal apparatus 40X is illustrated as Step S124, on the assumption that the adjustment partner X receives the electronic mail using the terminal apparatus 40X; however, the adjustment partner X may receive the notification email from the time/date adjustment apparatus 20, using an electronic device other than the terminal apparatus 40X. The same holds true for the adjustment initiator A and the terminal apparatus 40A.

In the present embodiment, notification to the adjustment initiator-side participants and the adjustment partner X is notified by using electronic mail; however, a notification means need not be electronic mail. For example, notification may be performed by using a chat tool used by the adjustment initiator-side participants and the adjustment partner X. Through the above processing, the time/date adjustment processing performed by the time/date adjustment system 10 ends.

Note that, in the present case, the adjustment initiator A does not designate a site of the assembly; however, when the adjustment initiator A designates site(s) in the selection input field 515 on the condition setting screen 500 (FIG. 7), the first candidate time/dates and the third candidate time/dates may be extracted such that available time/dates of at least one or more sites of the designated site(s) are satisfied as well.

Specifically, for example, when only “first meeting room” is designated as the site, in Step S115, the time/date adjustment unit 213 may read the adjustment condition registered in the time/date adjustment information 224 of the adjustment initiator A from the storage unit 22, refer to the schedule information 311 of the adjustment initiator-side participants and the first meeting room managed by the calendar tool 31 of the task management system 30, and extract time/dates that are available time/dates of the adjustment initiator-side participants satisfying the adjustment condition at the current time point and are available time/dates of the first meeting room as the first candidate time/dates. In Step S119, the time/date adjustment unit 213 may read the adjustment condition and the second candidate time/dates registered in the time/date adjustment information 224 of the adjustment initiator A corresponding to the accessed adjustment URL from the storage unit 22, refer to the schedule information 311 of the adjustment initiator-side participants and the first meeting room managed by the calendar tool 31, and extract time/dates that are available time/dates of the adjustment initiator-side participants satisfying the adjustment condition at the current time point, are available time/dates of the first meeting room, and are within a range of the second candidate time/dates as the third candidate time/dates. In Step S121, the time/date adjustment unit 213 may refer to the schedule information 311 of the adjustment initiator-side participants and the first meeting room managed by the calendar tool 31, and check that they are the available time/dates of the adjustment initiator-side participants at the current time point and are the available time/dates of the first meeting room. Furthermore, in Step S122, when the time/date adjustment unit 213 registers the plan of the assembly in the schedule information 311 of the adjustment initiator-side participants managed by the calendar tool 31, the time/date adjustment unit 213 may register the plan of the assembly, with an ID as the site that allows for identification of the first meeting room in the calendar tool 31 being designated in the item of the meeting room in the plan to be registered (as specifications of a general calendar tool, the plan is automatically reflected in the schedule information 311 of the first meeting room designated as the item of the meeting room, and the plan of the assembly of the first meeting room is secured).

For example, when two rooms of “first meeting room and second meeting room” are designated as the site, in Step S115, the time/date adjustment unit 213 may read the adjustment condition registered in the time/date adjustment information 224 of the adjustment initiator A from the storage unit 22, refer to the schedule information 311 of the adjustment initiator-side participants, the first meeting room, and the second meeting room managed by the calendar tool 31 of the task management system 30, and extract time/dates that are available time/dates of the adjustment initiator-side participants satisfying the adjustment condition at the current time point and are available time/dates of at least one room of the first meeting room and the second meeting room as the first candidate time/dates. In Step S119, the time/date adjustment unit 213 may read the adjustment condition and the second candidate time/dates registered in the time/date adjustment information 224 of the adjustment initiator A corresponding to the accessed adjustment URL from the storage unit 22, refer to the schedule information 311 of each of the adjustment initiator-side participants, the first meeting room, and the second meeting room managed by the calendar tool 31, and extract time/dates that are available time/dates of the adjustment initiator-side participants satisfying the adjustment condition at the current time point, are available time/dates of at least one room of the first meeting room and the second meeting room, and are within a range of the second candidate time/dates as the third candidate time/dates.

In Step S121, the time/date adjustment unit 213 may refer to the schedule information 311 of each of the adjustment initiator-side participants, the first meeting room, and the second meeting room managed by the calendar tool 31, and check that they are the available time/dates of the adjustment initiator-side participants at the current time point and are the available time/dates of at least one room of the first meeting room and the second meeting room. Furthermore, in Step S122, when only one room of the first meeting room and the second meeting room is available on the confirmed assembly time/date, the plan of the assembly may be registered with an ID as the site that allows for identification of the one available site in the calendar tool 31 being designated as the item of the meeting room in the plan to be registered.

When two rooms of the first meeting room and the second meeting room are available on the confirmed assembly time/date, one room out of the first meeting room and the second meeting room may be selected, and the plan of the assembly may be registered with an ID as the site that allows for identification of the selected site in the calendar tool 31 being designated as the item of the meeting room in the plan to be registered. Note that order of priority of the site selected may follow a predetermined rule, or may be designated by the adjustment initiator A.

Note that, in the present embodiment, the description has been given based on an assumption that the adjustment initiator A does not edit the second candidate time/dates after the adjustment initiator A confirms the second candidate time/dates in Step S117; however, the adjustment initiator A may be able to edit the second candidate time/dates after Step S117 and before the adjustment partner X accesses the adjustment URL in Step S131. Note that, even in that case, similarly to the present embodiment, the time/date adjustment unit 213 may extract the third candidate time/dates by using the second candidate time/dates registered in the time/date adjustment information 224 at the time point when the adjustment partner X accesses the adjustment URL.

In the present embodiment, at a timing when the adjustment initiator A confirms the second candidate time/dates and the time/date adjustment unit 213 issues the adjustment URL, without the time/date adjustment unit 213 registering any plans in the schedule information 311 of the adjustment initiator-side participants, subsequent time/date adjustment processing can be performed without causing a double booking. Note that a method of preventing a double booking is not limited only to the present embodiment. For example, as a modification, at a timing when the adjustment initiator A confirms the second candidate time/dates and the time/date adjustment unit 213 issues the adjustment URL, by registering a “tentative plan” for preventing other plans from being additionally registered in the time/dates as the second candidate time/date in the schedule information 311 of the adjustment initiator-side participants, other plans may be prevented from being additionally registered in the time/dates of the “tentative plan” afterwards. Note that, in the modification, when the time/date adjustment unit 213 displays the third candidate time/dates on the time/date adjustment screen 800, on an assumption that other plans are not additionally registered in the time/dates in which the “tentative plan” is registered (in other words, the time/dates in which the “tentative plan” is registered are the available time/dates of the adjustment initiator-side participants), the time/dates of the “tentative plan” registered in the schedule information 311 of the adjustment initiator-side participants in advance or the time/dates of the “tentative plan” recorded in the time/date adjustment information 224 or the like in advance may be referred to, and the time/dates of the “tentative plan” may be displayed on the time/date adjustment screen 800 as the third candidate time/dates. Alternatively, on an assumption that the “tentative plan” may have been changed and a plan may have been additionally registered in a part of the time/dates overlapping the “tentative plan” in the schedule information 311 of the adjustment initiator-side participants, the time/dates of the “tentative plan” registered in the schedule information 311 of the adjustment initiator-side participants or the time/dates of the “tentative plan” recorded in the time/date adjustment information 224 or the like may be extracted, and the time/dates that are within a range of the extracted time/dates of the “tentative plan” and are available time/dates of the adjustment initiator-side participants satisfying the adjustment condition may be displayed on the time/date adjustment screen 800 as the third candidate time/dates.

Note that, in the present embodiment, the description has been given based on an assumption that the adjustment partner X is not a user of the time/date adjustment apparatus 20; however, it is also assumed that the adjustment partner X is a user of the time/date adjustment apparatus 20 (the adjustment partner X may be a user belonging to the same corporate member as the corporate member to which the adjustment initiator A belongs, may be a user belonging to a corporate member different from the corporate member to which the adjustment initiator A belongs, or may be a user of an individual member).

When the adjustment partner X is a user belonging to a certain corporate member of the time/date adjustment apparatus 20, a “change adjustment condition” button (not illustrated) is additionally provided on a screen of the time/date adjustment screen 800 (FIG. 9) displayed in the terminal apparatus 40X of the adjustment partner X by the time/date adjustment unit 213, and the adjustment partner-side participants and the site (meeting room or the like) to be used for the assembly by the adjustment partner-side participants can be changed in a selection input field displayed in response to operation being performed on the “change adjustment condition” button. Note that, in the initial value, the adjustment partner-side participant(s) is only the adjustment partner X and the site to be used for the assembly by the adjustment partner-side participant(s) is “not selected”, and by performing operation on the “change adjustment condition” button, the adjustment partner X can change the adjustment partner-side participant(s) and the site to be used for the assembly by the adjustment partner-side participant(s) from the initial value as necessary.

When the adjustment partner X is a user belonging to a certain corporate member of the time/date adjustment apparatus 20, the time/date adjustment apparatus 20 can already refer to the schedule information 311 of the adjustment partner-side participants and the sites available to be used for the assembly by the adjustment partner-side participants, and thus the time/date adjustment unit 213 refers to the schedule information 311 of the adjustment partner-side participants and the sites set in the “change adjustment condition” button, and additionally displays display frames (not illustrated) representing existing plans of the adjustment partner-side participants and the sites in the calendar 801 on the time/date adjustment screen 800 (FIG. 9), and in that case, the display frames are displayed in different colors or the like so that the display frames can be distinguished from the third candidate time/date frames 802 in the calendar 801. In other words, when the adjustment partner X is a user belonging to a certain corporate member of the time/date adjustment apparatus 20, the adjustment partner X can check selected existing plans of the adjustment partner-side participants and the sites in the calendar 801 in which the third candidate time/date frames 802 are displayed, and can thus very easily select the time/dates of the assembly. Note that, on the time/date confirmation screen 900 (FIG. 10) as well, similarly, the existing plans of the adjustment partner-side participants and the sites are displayed in the calendar 901.

Furthermore, when the adjustment partner X is a user belonging to a certain corporate member of the time/date adjustment apparatus 20, the time/date adjustment apparatus 20 stores the email addresses of the adjustment partner X and the adjustment partner-side participants designated by the adjustment partner X, and thus the input field 904 on the time/date confirmation screen 900 (FIG. 10) for the adjustment partner X to input the email address of the adjustment partner X and the email addresses of the adjustment partner-side participants is not displayed (it may be displayed with values being input in advance and the adjustment partner X may be able to change the values).

It is also assumed that the adjustment partner X is a user of a certain individual member of the time/date adjustment apparatus 20. When the adjustment partner X is a user of a certain individual member of the time/date adjustment apparatus 20, the adjustment partner-side participants other than the adjustment partner X and the sites to be used for the assembly by the adjustment partner X cannot be designated in the “change adjustment condition” button, but the rest (display of the existing plans of the adjustment partner X themselves on the time/date adjustment screen 800 (FIG. 9) and the time/date confirmation screen 900 (FIG. 10) and non-display of the input field 904) is similar to the case in which the adjustment partner X is a user belonging to a certain corporate member.

In addition, when the adjustment partner X is a user belonging to a certain corporate member of the time/date adjustment apparatus 20 or a user of a certain individual member, the time/date adjustment apparatus 20 already recognizes the calendar tool 31 usually used by the adjustment partner-side participants (the adjustment partner X only when the adjustment partner X is a user of an individual member), and thus the registration button 1001 and the registration button 1002 are not displayed on the time/date notification screen 1000 (FIG. 12 and FIG. 13) (further, the text displayed on the left side of each button is also changed, considering that the adjustment partner X is a user). The time/date adjustment apparatus 20 can register the plan in the schedule information 311 of the adjustment partner-side participants, and thus when the adjustment partner-side participants are not added to the item of the assembly participants of the plan (when the time/date notification screen 1000 of FIG. 13 is displayed for the adjustment partner X) in the plan to be registered in the schedule information 311 of the adjustment initiator-side participants, the time/date adjustment unit 213 registers the plan of the adjustment partner-side participants in the schedule information 311 of the adjustment partner-side participants. Note that the items (the topic of the plan and the like) necessary for registration of the plan may be input on the time/date confirmation screen 900 by the adjustment partner X. Alternatively, they may be automatically generated by the time/date adjustment unit 213 by using information of the adjustment initiator A and the like.

According to the time/date adjustment processing described above, adjustment of a time/date of an assembly can be easily performed without causing a double booking. Switching between individual registration of the confirmed plan in the schedule on each of the adjustment initiator A side and the adjustment partner X side and integrated registration of both of the confirmed plan to be registered on the adjustment partner X side and the confirmed plan to be registered on the adjustment initiator A side in the schedule on the adjustment initiator A side can be easily or automatically performed depending on assembly details or belonging of the adjustment partner X.

In addition, according to the time/date adjustment processing, from the standpoint of the adjustment initiator A, operations from extraction of the candidate time/dates to transmission of the candidate time/dates to the adjustment partner X can be performed in a short period of time (for example, approximately 30 seconds), and after transmitting the candidate time/dates to the adjustment partner X, the adjustment initiator A only has to wait and can have important operations regarding time/date adjustment automatically completed, including not only determination of the time/date but also securing of the site and registration of the plan, and accordingly, time and efforts for the operations regarding time/date adjustment can be significantly reduced.

Furthermore, according to the time/date adjustment processing, whether or not to perform integrated registration of both of the confirmed plan to be registered on the adjustment partner X side and the confirmed plan to be registered on the adjustment initiator A side in the schedule on the adjustment initiator A side can be easily or automatically switched depending on assembly details or belonging of the adjustment partner X (or the adjustment partner-side participant), and in a case of integrated registration, information to be prepared for the assembly can be easily shared in advance and meeting minutes and the like can be easily shared after the assembly between the adjustment initiator-side participants and the adjustment partner X (or the adjustment partner-side participants) by using the memo information and the like of the registered plan. In a case of individual registration without integration, the plan on the adjustment initiator A side and the plan on the adjustment partner X side are separate pieces of plan information, and thus, for example, details (information to be shared only among the adjustment initiator-side participants for a business discussion or the like) that the adjustment initiator A side desires to keep secret from the adjustment partner X side can be shared only among the adjustment initiator-side participants and can be kept secret from the adjustment partner X (and the adjustment partner-side participants). In other words, depending on assembly details and belonging of the adjustment partner, information can be easily shared and information can be easily kept confidential.

### Case in Which “Use Template” is Selected as Method of Time/Date Adjustment

Next, a case in which the adjustment initiator A selects “use template” as the method of time/date adjustment will be described. In a case of “use template”, the adjustment condition template created by the adjustment initiator A themselves in advance is selected, and the adjustment URL designated by the adjustment initiator A themselves in advance is copied, and the adjustment URL can be thereby more promptly transmitted to the adjustment partner X, in comparison to customized adjustment. Note that the adjustment condition template created by the adjustment initiator A in advance may be designated and edited by another user, and the adjustment URL may be copied and used for time/date adjustment.

A user such as the adjustment initiator A can create the adjustment condition templates in advance, depending on a purpose of the assembly, such as “for a first interview for recruitment of a new graduate”, “for a second interview for recruitment of a new graduate”, “for a final interview for recruitment of a new graduate”, and “for sales for an inquiry”, for example.

Note that, in a case of “customized adjustment”, the adjustment condition is set every time adjustment of a time/date of an assembly is performed; however, the adjustment condition template can be repeatedly used for adjustment of time/dates of different assemblies again and again.

### Adjustment Condition Template Creation Processing

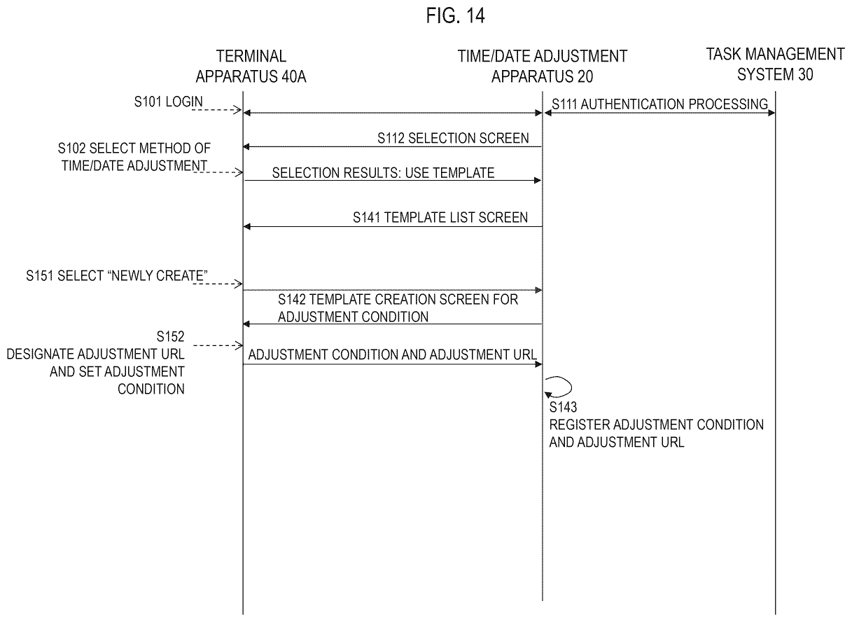

Next, FIG. 14 is a sequence diagram for illustrating an example of adjustment condition template creation processing.

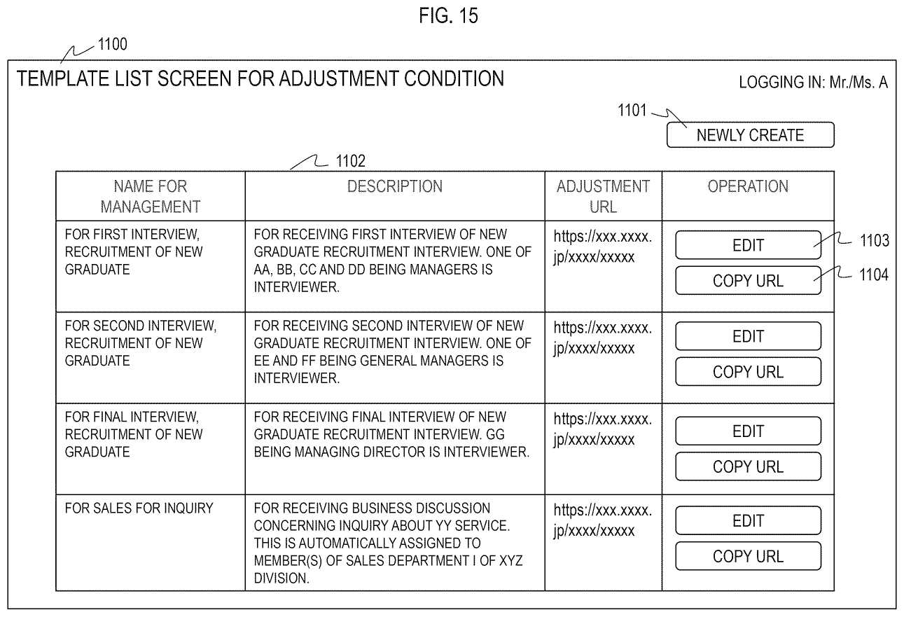

The adjustment condition template creation processing includes Steps S101, S111, S112, and S102 similar to those of the time/date adjustment processing illustrated in FIG. 6. Then, when the adjustment initiator A selects “use template” as the method of time/date adjustment in Step S102, next, the adjustment condition setting unit 212 of the time/date adjustment apparatus 20 refers to the adjustment condition template information 223 associated with the user information 222 corresponding to the adjustment initiator A, and causes the terminal apparatus 40A to display a template list screen 1100 (FIG. 15) presenting a list of adjustment condition templates available to the adjustment initiator A (Step S141).

FIG. 15 illustrates a display example of the template list screen 1100 displayed in the terminal apparatus 40A.

The template list screen 1100 is provided with a newly create button 1101 and a template list 1102 presenting a list of adjustment condition templates available to the adjustment initiator A. In the template list 1102, a name for management, a description, an adjustment URL, an edit button 1103, and a URL copy button 1104 are displayed for each template.

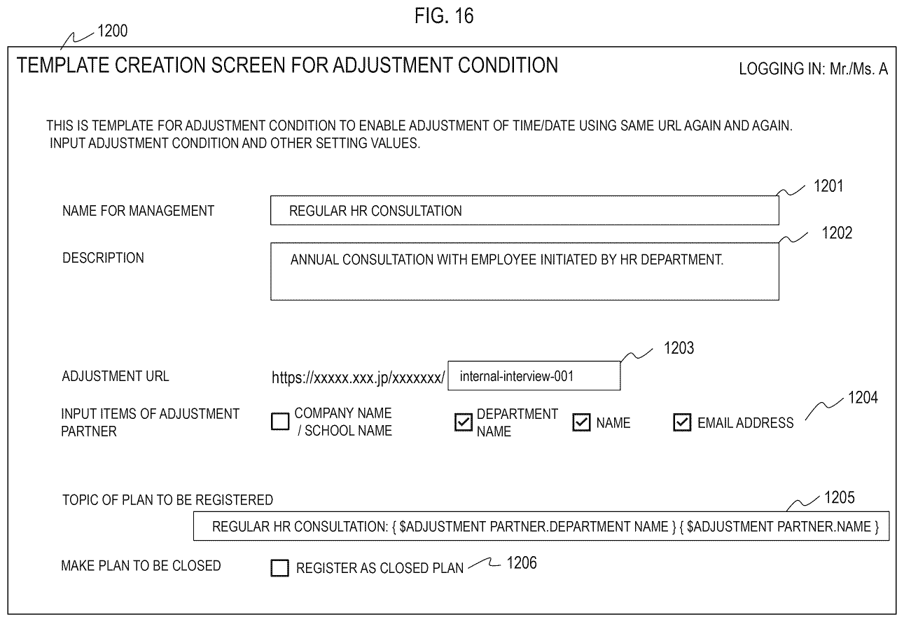

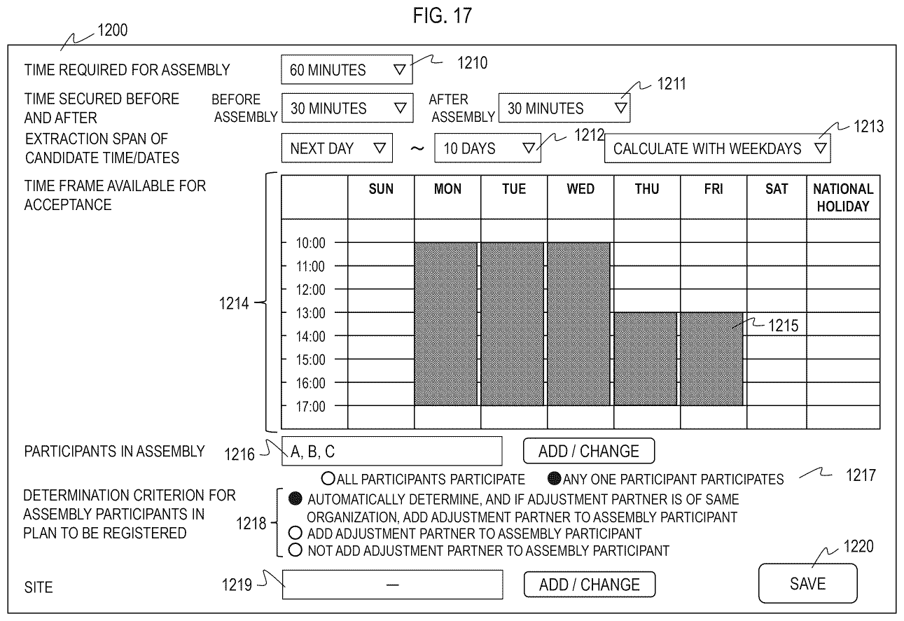

The newly create button 1101 is a button for instructing proceeding to a template creation screen 1200 (FIG. 16 and FIG. 17), on which a new adjustment condition template can be created. The edit button 1103 is a button for instructing proceeding to a screen (not illustrated; similar to the template creation screen 1200), on which a created adjustment condition template can be edited. The URL copy button 1104 is a button for instructing copying of the adjustment URL.

FIG. 14 is referred to again. When the adjustment initiator A performs operation on the newly create button 1101 on the template list screen 1100 displayed in the terminal apparatus 40A (Step S151), next, the adjustment condition setting unit 212 causes the terminal apparatus 40A to display the template creation screen 1200 (Step S142).

FIG. 16 and FIG. 17 illustrate display examples of the template creation screen 1200. FIG. 16 illustrates an upper part of the template creation screen 1200, and FIG. 17 illustrates a lower part of the template creation screen 1200, which is displayed by scrolling down the upper part illustrated in FIG. 16.

As illustrated in FIG. 16, the template creation screen 1200 is provided with an input field 1201 for inputting a name for management of the template, an input field 1202 for inputting a description of the template, an input field 1203 for the user to designate an adjustment URL, a check box 1204 for designating a company name/school name, a department name, a name, and an email address as input items of the adjustment partner X, an input field 1205 for inputting the topic of the plan to be used in registration in the calendar tool 31 after the time/date is confirmed, and a check box 1206 for selecting whether or not to register the plan of the assembly as a closed plan.

Moreover, as illustrated in FIG. 17, the template creation screen 1200 is further provided with a selection input field 1210 for inputting the time required for the assembly, a selection input field 1211 for inputting the time secured before and after the assembly, a selection input field 1212 for inputting the extraction span of the candidate time/dates, a selection input field 1213 for selecting and inputting a method of calculating the number of days to be extracted for the extraction span (for example, calculation with weekdays, calculation with calendar days, or the like), an input field 1214 for designating a time frame available for the assembly for each day of the week and national holiday (a frame 1215 denotes a time frame designated as the time frame available for the assembly), a selection input field 1216 for selecting and designating one or more adjustment initiator-side participants (which may or may not include the adjustment initiator A) out of the belonging member list based on the belonging member information of the member information 221, a radio button 1217 for selecting the assembly participation condition of the adjustment initiator-side participant(s) designated in the selection input field 1216, a radio button 1218 for selecting and designating the determination criterion as to whether or not to add the adjustment partner-side participants to the item of the assembly participants in the plan of the assembly to be registered in the schedule information 311 of the adjustment initiator-side participants, a selection input field 1219 for selecting and designating one or more rooms of the sites to be used for the assembly out of the site list based on the site information of the member information 221, and a “save” button 1220 for instructing saving of the input contents.

In the radio button 1218, “automatically determine, and if adjustment partner is of same organization, add adjustment partner to assembly participant”, “add adjustment partner to assembly participant”, or “not add adjustment partner to assembly participant” can be selected as the determination criterion. Note that the radio button 1218 may be omitted, and the determination criterion may be fixed to “automatically determine, and if adjustment partner is of same organization, add adjustment partner to assembly participant”.

Note that, in the selection input field 1212 for inputting the extraction span of the candidate time/dates on the template creation screen 1200, start timing (in the case of the figure, next day) of the extraction span from the date and time on which the adjustment partner performs access based on the adjustment URL and a span (in the case of the figure, 10 days) from the start timing can be designated in order to provide versatility, unlike the selection input field 513 of a similar purpose provided on the condition setting screen 500 (FIG. 7) corresponding to customized adjustment where a specific date, month, and year are selected. Thus, the adjustment condition template can be repeatedly used for adjustment of time/dates of different assemblies again and again.

FIG. 14 is referred to again. When the adjustment initiator A finishes inputting each item of the adjustment condition and then performs operation on the “save” button 1220 on the template creation screen 1200 displayed in the terminal apparatus 40A (Step S152), next, the adjustment condition setting unit 212 creates the adjustment condition template information 223, registers the adjustment condition and the adjustment URL set on the template creation screen 1200, and records the adjustment condition template information 223 in the storage unit 22 in association with the user information 222 of the adjustment initiator A (Step S143). Through the above processing, the processing of creating the adjustment condition template ends.

### Time/Date Adjustment Processing Using Adjustment Condition Template

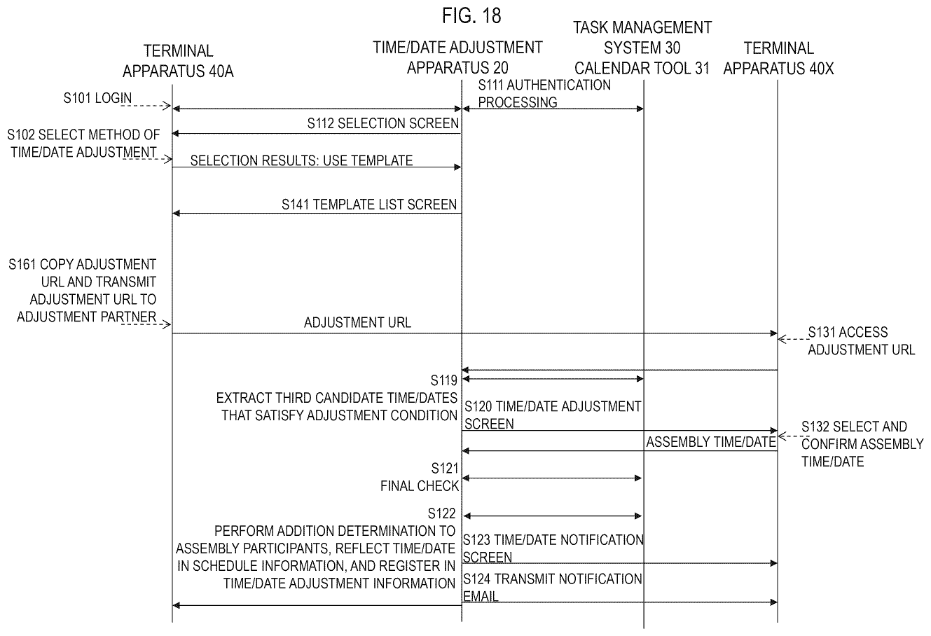

Next, FIG. 18 is a sequence diagram for illustrating another example of the time/date adjustment processing using the adjustment condition template.

Such another example includes Steps S101, S111, S112, S102, and S141 similar to those of the adjustment condition template creation processing illustrated in FIG. 14. Then, in Step S141, on the template list screen 1100 (FIG. 15) displayed in the terminal apparatus 40A, the adjustment initiator A selects one of the templates, performs operation on the URL copy button 1104 to copy the adjustment URL, pastes the adjustment URL to an electronic mail or the like, and transmits the adjustment URL to the terminal apparatus 40X of the adjustment partner X (Step S161).

The following processing is similar to the time/date adjustment processing of FIG. 6, and thus description thereof will be omitted. Note that, in the present case, in Step S119, the second candidate time/dates are not present, and thus the available time/dates of the adjustment initiator-side participants satisfying the adjustment condition at the current time point may be extracted as the third candidate time/dates. In the present case, the time/date confirmation screen 900 (FIG. 10) displayed in Step S132 is provided with input fields corresponding to the items selected in the check box 1204 as the input items of the adjustment partner on the template creation screen 1200 (FIG. 16) (an input field for inputting a department name, an input field for inputting a name), in addition to the input field 904 for inputting an email address. Moreover, in the present case, in Step 122, the topic of the plan to be registered in the schedule information 311 of the adjustment initiator-side participants can be generated by combining fixed text and the department name, the name, and the like input by the adjustment partner X in the input fields corresponding to the items selected in the check box 1204.

According to another example of the time/date adjustment processing described above (a case of selecting use of the adjustment condition template), in addition to effects similar to those of the time/date adjustment processing of FIG. 6 (a case of selecting customized adjustment), the adjustment initiator A merely selects the adjustment condition template and transmits the adjustment URL as their operation, and therefore time and efforts taken by the adjustment initiator A can be significantly reduced, in comparison to the case of customized adjustment.

In addition, in time/date adjustment in business, a pattern of the participants, the site, the time frame, and the like is, to a certain degree, determined for each situation (type of assembly), such as an interview, a consultation, a sales visit, having a visitor, and a web meeting. Thus, once the adjustment condition template for each situation is created and registered in advance, by merely selecting the template, the adjustment URL can be instantly transmitted to the adjustment partner X.

Because the adjustment condition template can be repeatedly used and the adjustment URL corresponding to each adjustment condition template is fixed, for example, by attaching a link of the adjustment URL subsequently to an inquiry form of a website of a company, time/date adjustment can be performed without the time and efforts taken to transmit the adjustment URL to the adjustment partner X.

By attaching the adjustment URL to an email for simultaneous distribution or the like, the adjustment URL can be simultaneously transmitted to a plurality of adjustment partners X.

Typically, for example, the time/date adjustment apparatus of the present embodiment can prepare various operation screens as web pages, and can display such operation screens in a web browser of the terminal apparatus. However, this aspect is not restrictive. For example, a dedicated application including various operation screens may be installed in the terminal apparatus. In this case, by transmitting a part of contents (data such as candidate time/dates) to be displayed on various operation screens to the terminal apparatus, the time/date adjustment apparatus can cause the dedicated application of the terminal apparatus to display various operation screens. In other words, the time/date adjustment apparatus of the present invention may also encompass various aspects in which screens can be displayed in the terminal apparatus.

The present invention is not limited to the embodiments and modifications described above, and further various modifications can be made. For example, the embodiments and the modifications described above are described in detail in order to give simple description of the present invention, and are not necessarily limited to those including all of the configurations described above. A part of one modification may be replaced with another modification, or modifications may be combined together.

A part or all of each configuration, function, processing unit, processing means, and the like described above may be, for example, implemented with hardware by designing those with an integrated circuit, for example. Each configuration, function, and the like described above may be implemented with software by a processor interpreting and executing a program for implementing their respective functions. Information such as a program, a table, and a file for implementing respective functions may be stored in a recording apparatus such as a memory, a hard disk, and an SSD, or a recording medium such as an IC card, an SD card, and a DVD. Illustrated control lines and information lines are those considered to be necessary for the sake of description, and not necessarily all of control lines and information lines for a product are illustrated. It may be considered that most of the configurations are connected to each other in actuality.

### REFERENCE SIGNS LIST

10 . . . Time/date adjustment system,
11 . . . Network,
20 . . . Time/date adjustment apparatus,
21 . . . Processing unit,
211 . . . Authentication unit,
212 . . . Adjustment condition setting unit,
213 . . . Time/date adjustment unit,
22 . . . Storage unit,
221 . . . Member information,
222 . . . User information,
223 . . . Adjustment condition template information,
224 . . . Time/date adjustment information,
23 . . . Communication unit,
30 . . . Task management system,
31 . . . Calendar tool,
311 . . . Schedule information,
40A, 40M, 40X . . . Terminal apparatus,
300 . . . Same organization determination condition setting screen,
500 . . . Condition setting screen,
600 . . . Time/date editing screen,
800 . . . Time/date adjustment screen,
900 . . . Time/date confirmation screen,
1000 . . . Time/date notification screen,
1100 . . . Template list screen,
1200 . . . Template creation screen

1. A time/date adjustment apparatus comprising:
an adjustment condition setting unit configured to set an adjustment condition related to an assembly; and
a time/date adjustment unit configured to adjust an assembly time/date based on the adjustment condition, wherein
the adjustment condition setting unit sets, in response to an input of an adjustment initiator, the adjustment condition including designation of an adjustment initiator-side participant and designation of a determination criterion as to whether or not to add an adjustment partner-side participant to an item of an assembly participant of plan information to be registered in schedule information of the adjustment initiator-side participant,
the time/date adjustment unit extracts, in response to an adjustment partner performing access based on access information, available time/dates of the adjustment initiator-side participant as candidate time/dates,
the time/date adjustment unit causes a terminal apparatus used by the adjustment partner to display a time/date adjustment screen presenting the extracted candidate time/dates,
the time/date adjustment unit determines, in response to a selection operation of the adjustment partner on the time/date adjustment screen, the assembly time/date out of the candidate time/dates,
the time/date adjustment unit registers the plan information of the determined assembly time/date in the schedule information of the adjustment initiator-side participant, with the adjustment initiator-side participant being designated as the item of the assembly participant of the plan information, and
the time/date adjustment unit adds or does not add the adjustment partner-side participant to the item of the assembly participant of the plan information to be registered, according to the determination criterion.

2. A time/date adjustment apparatus comprising:
an adjustment condition setting unit configured to set an adjustment condition related to an assembly; and
a time/date adjustment unit configured to adjust an assembly time/date based on the adjustment condition, wherein
the adjustment condition setting unit sets, in response to an input of an adjustment initiator or a member administrator of an organization to which the adjustment initiator belongs, a determination condition for determining whether or not an adjustment partner-side participant belongs to a same organization as the adjustment initiator,
the adjustment condition setting unit sets, in response to the input of the adjustment initiator, the adjustment condition including designation of an adjustment initiator-side participant,
the time/date adjustment unit extracts, in response to an adjustment partner performing access based on access information, available time/dates of the adjustment initiator-side participant as candidate time/dates,
the time/date adjustment unit causes a terminal apparatus used by the adjustment partner to display a time/date adjustment screen presenting the extracted candidate time/dates,
the time/date adjustment unit determines, in response to a selection operation of the adjustment partner on the time/date adjustment screen, the assembly time/date out of the candidate time/dates,
the time/date adjustment unit determines whether or not the adjustment partner-side participant belongs to the same organization as the adjustment initiator, based on the determination condition,
the time/date adjustment unit registers plan information of the determined assembly time/date in schedule information of the adjustment initiator-side participant, with the adjustment initiator-side participant being designated as an item of an assembly participant of the plan information, and
when the adjustment partner-side participant belongs to the same organization as the adjustment initiator, the time/date adjustment unit adds the adjustment partner-side participant to the item of the assembly participant of the plan information to be registered.

3. The time/date adjustment apparatus according to claim 1, wherein
the plan information registered in the schedule information and the plan information edited after being registered are shared between the adjustment initiator-side participant designated as the item of the assembly participant of the plan information registered in the schedule information and the adjustment partner-side participant added to the item of the assembly participant of the plan information registered in the schedule information.

4. The time/date adjustment apparatus according to claim 2, wherein
the adjustment condition setting unit sets at least one of an email domain and an email address as the determination condition, and
the time/date adjustment unit determines whether or not the adjustment partner-side participant belongs to the same organization as the adjustment initiator, based on the email address of the adjustment partner-side participant and the determination condition.

5. The time/date adjustment apparatus according to claim 2, further comprising
a storage unit configured to store belonging member information presenting a list of belonging members belonging to the same organization, wherein
the time/date adjustment unit refers to the belonging member information corresponding to the adjustment initiator, and thereby determines whether or not the adjustment partner-side participant belongs to the same organization as the adjustment initiator.

6. The time/date adjustment apparatus according to claim 1, wherein
the time/date adjustment unit refers to, in response to the adjustment partner performing access based on the access information, the schedule information of the adjustment initiator-side participant managed by a calendar tool, and extracts the available time/dates of the adjustment initiator-side participant satisfying the adjustment condition as the candidate time/dates.

7. The time/date adjustment apparatus according to claim 1, wherein
the time/date adjustment unit registers, in response to an operation from the adjustment partner, the plan information of the determined assembly time/date in the schedule information of the adjustment partner-side participant.

8. A time/date adjustment method performed by a time/date adjustment apparatus, the time/date adjustment method comprising:
an adjustment condition setting step of setting an adjustment condition related to an assembly; and
a time/date adjustment step of adjusting an assembly time/date based on the adjustment condition, wherein
the adjustment condition setting step includes, in response to an input of an adjustment initiator, setting the adjustment condition including designation of an adjustment initiator-side participant and designation of a determination criterion as to whether or not to add an adjustment partner-side participant to an item of an assembly participant of plan information to be registered in schedule information of the adjustment initiator-side participant,
the time/date adjustment step includes, in response to an adjustment partner performing access based on access information, extracting available time/dates of the adjustment initiator-side participant as candidate time/dates,
the time/date adjustment step includes causing a terminal apparatus used by the adjustment partner to display a time/date adjustment screen presenting the extracted candidate time/dates,
the time/date adjustment step includes, in response to a selection operation of the adjustment partner on the time/date adjustment screen, determining the assembly time/date out of the candidate time/dates,
the time/date adjustment step includes registering the plan information of the determined assembly time/date in the schedule information of the adjustment initiator-side participant, with the adjustment initiator-side participant being designated as the item of the assembly participant of the plan information, and
the time/date adjustment step includes adding or not adding the adjustment partner-side participant to the item of the assembly participant of the plan information to be registered, according to the determination criterion.

9. A non-transitory computer-readable storage medium storing a program causing a computer to function as:
an adjustment condition setting unit configured to set an adjustment condition related to an assembly; and
a time/date adjustment unit configured to adjust an assembly time/date based on the adjustment condition, wherein
the adjustment condition setting unit sets, in response to an input of an adjustment initiator, the adjustment condition including designation of an adjustment initiator-side participant and designation of a determination criterion as to whether or not to add an adjustment partner-side participant to an item of an assembly participant of plan information to be registered in schedule information of the adjustment initiator-side participant,
the time/date adjustment unit extracts, in response to an adjustment partner performing access based on access information, available time/dates of the adjustment initiator-side participant as candidate time/dates,
the time/date adjustment unit causes a terminal apparatus used by the adjustment partner to display a time/date adjustment screen presenting the extracted candidate time/dates,
the time/date adjustment unit determines, in response to a selection operation of the adjustment partner on the time/date adjustment screen, the assembly time/date out of the candidate time/dates,
the time/date adjustment unit registers the plan information of the determined assembly time/date in the schedule information of the adjustment initiator-side participant, with the adjustment initiator-side participant being designated as the item of the assembly participant of the plan information, and
the time/date adjustment unit adds or does not add the adjustment partner-side participant to the item of the assembly participant of the plan information to be registered, according to the determination criterion.

10. A time/date adjustment method performed by a time/date adjustment apparatus, the time/date adjustment method comprising:
an adjustment condition setting step of setting an adjustment condition related to an assembly; and
a time/date adjustment step of adjusting an assembly time/date based on the adjustment condition, wherein
the adjustment condition setting step includes, in response to an input of an adjustment initiator or a member administrator of an organization to which the adjustment initiator belongs, setting a determination condition for determining whether or not an adjustment partner-side participant belongs to a same organization as the adjustment initiator,
the adjustment condition setting step includes, in response to the input of the adjustment initiator, setting the adjustment condition including designation of an adjustment initiator-side participant,
the time/date adjustment step includes, in response to an adjustment partner performing access based on access information, extracting available time/dates of the adjustment initiator-side participant as candidate time/dates,
the time/date adjustment step includes causing a terminal apparatus used by the adjustment partner to display a time/date adjustment screen presenting the extracted candidate time/dates,
the time/date adjustment step includes, in response to a selection operation of the adjustment partner on the time/date adjustment screen, determining the assembly time/date out of the candidate time/dates,
the time/date adjustment step includes determining whether or not the adjustment partner-side participant belongs to the same organization as the adjustment initiator, based on the determination condition,
the time/date adjustment step includes registering plan information of the determined assembly time/date in schedule information of the adjustment initiator-side participant, with the adjustment initiator-side participant being designated as an item of an assembly participant of the plan information, and
when the adjustment partner-side participant belongs to the same organization as the adjustment initiator, the time/date adjustment step includes adding the adjustment partner-side participant to the item of the assembly participant of the plan information to be registered.

11. A non-transitory computer-readable storage medium storing a program causing a computer to function as:
an adjustment condition setting unit configured to set an adjustment condition related to an assembly; and
a time/date adjustment unit configured to adjust an assembly time/date based on the adjustment condition, wherein
the adjustment condition setting unit sets, in response to an input of an adjustment initiator or a member administrator of an organization to which the adjustment initiator belongs, a determination condition for determining whether or not an adjustment partner-side participant belongs to a same organization as the adjustment initiator,
the adjustment condition setting unit sets, in response to the input of the adjustment initiator, the adjustment condition including designation of an adjustment initiator-side participant,
the time/date adjustment unit extracts, in response to an adjustment partner performing access based on access information, available time/dates of the adjustment initiator-side participant as candidate time/dates,
the time/date adjustment unit causes a terminal apparatus used by the adjustment partner to display a time/date adjustment screen presenting the extracted candidate time/dates,
the time/date adjustment unit determines, in response to a selection operation of the adjustment partner on the time/date adjustment screen, the assembly time/date out of the candidate time/dates,
the time/date adjustment unit determines whether or not the adjustment partner-side participant belongs to the same organization as the adjustment initiator, based on the determination condition,
the time/date adjustment unit registers plan information of the determined assembly time/date in schedule information of the adjustment initiator-side participant, with the adjustment initiator-side participant being designated as an item of an assembly participant of the plan information, and
when the adjustment partner-side participant belongs to the same organization as the adjustment initiator, the time/date adjustment unit adds the adjustment partner-side participant to the item of the assembly participant of the plan information to be registered.

12. The time/date adjustment apparatus according to claim 2, wherein
the plan information registered in the schedule information and the plan information edited after being registered are shared between the adjustment initiator-side participant designated as the item of the assembly participant of the plan information registered in the schedule information and the adjustment partner-side participant added to the item of the assembly participant of the plan information registered in the schedule information.

13. The time/date adjustment apparatus according to claim 2, wherein
the time/date adjustment unit refers to, in response to the adjustment partner performing access based on the access information, the schedule information of the adjustment initiator-side participant managed by a calendar tool, and extracts the available time/dates of the adjustment initiator-side participant satisfying the adjustment condition as the candidate time/dates.

14. The time/date adjustment apparatus according to claim 2, wherein
the time/date adjustment unit registers, in response to an operation from the adjustment partner, the plan information of the determined assembly time/date in the schedule information of the adjustment partner-side participant.
